(19) United States
(12) Patent Application Publication
(10) Pub. No.: US 2026/0335882 A1
(43) Pub. Date: Oct. 29, 2026

(54) Reagent Molding for Point-of-Care Microfluidic Cartridges

(71) Applicants: Jennifer Blain, Chandler, AZ (US); Vi Nguyen, Phoenix, AZ (US)

(72) Inventors: Jennifer Blain, Chandler, AZ (US); Vi Nguyen, Phoenix, AZ (US)

(21) Appl. No.: 19/657,871

(22) Filed: Apr. 24, 2026

Related U.S. Application Data
(60) Provisional application No. 63/794,122, filed on Apr. 24, 2025.

(51) Int. Cl. B01L 3/00

(52) U.S. Cl. CPC B01L 3/502707; B01L 2200/027; B01L 2200/16; B01L 2300/12

(57) ABSTRACT

A method of creating a solidified reagent for use in a microfluidic cartridge includes forming a mold casing having a desired shape. Liquid silicone is poured into the mold casing and the liquid silicone is allowed to set to create a reagent mold. The reagent mold is released from the mold casing. The reagent mold includes a base with a cavity having a non-spherical shape. The cavity of the reagent mold is filled with a liquid reagent. The liquid reagent in the reagent mold is frozen to form a solidified reagent conforming to the non-spherical shape of the cavity. The solidified reagent is freed from the reagent mold when the reagent mold becomes pliable. The solidified reagent is rapidly cooled using a cryogenic fluid. The solidified reagent may be lyophilized.

### CROSS-REFERENCE TO RELATED APPLICATION

This application claims priority to U.S. Provisional Application No. 63/794,122, filed Apr. 24, 2025, which is hereby incorporated by reference in its entirety.

### BACKGROUND

Point-of-care (POC) devices are diagnostic tools that allow for rapid test results at or near the site of patient care, eliminating the need to send test samples to centralized laboratories for analysis. By providing prompt diagnostic information, POC devices can significantly reduce the time between sample collection and clinical decision-making, thereby improving patient outcomes and reducing healthcare costs. However, conventional POC devices present several challenges that limit their widespread adoption and effectiveness. Many POC systems require preprocessing of samples using standard laboratory equipment, such as a centrifuge.

Accordingly, there exists a need for a POC device and corresponding reagents that addresses these limitations by being stable in various climates and temperatures, user-friendly such that personnel without formal training can process samples and operate the device with minimal instruction, and by being affordable for widespread deployment in resource-limited settings. Such designs could greatly improve the accuracy, usability, and accessibility of POC diagnostic testing while remaining cost-effective for both healthcare providers and patients.

### SUMMARY

According to one aspect of the present disclosure, a method of creating a solidified reagent for use in a microfluidic cartridge can include forming a mold casing having a desired shape. Liquid silicone may be poured into the mold casing and the liquid silicone may be allowed to set to create a reagent mold. The reagent mold can be released from the mold casing. The reagent mold may include a base with a cavity having a non-spherical shape. The cavity of the reagent mold can be filled with a liquid reagent. The liquid reagent in the reagent mold can be frozen to form a solidified reagent conforming to the non-spherical shape of the cavity. The solidified reagent may be freed from the reagent mold when the reagent mold becomes pliable. The solidified reagent can be rapidly cooled using a cryogenic fluid. The solidified reagent may be lyophilized.

According to another aspect of the present disclosure, a reagent mold for solidifying liquid reagents for use in microfluidic cartridges can include a silicone base and a plurality of cavities formed in the silicone base. Each cavity may have a non-spherical shape configured to receive a liquid reagent and form a solidified reagent having a profile and size substantially matching a corresponding reaction chamber of a microfluidic cartridge. The silicone base can have a durometer configured to allow the reagent mold to become pliable when the solidified reagents are frozen.

According to another aspect of the present disclosure, a method of analyzing a test sample using a microfluidic cartridge having a plurality of reaction chambers, a waste reservoir, and a silica membrane can include installing a plurality of non-spherical lyophilized reagents into the plurality of reaction chambers. The test sample can be collected. A clip on the microfluidic cartridge can be installed in a first position to block fluid flow to the plurality of reaction chambers. The test sample can be provided to an input hole of the microfluidic cartridge. The clip may be placed in a second position to block fluid flow to the waste reservoir and open fluid flow to the plurality of reaction chambers. An elution buffer can be added through the input hole to rehydrate the lyophilized reagents. The test sample can be analyzed within the plurality of reaction chambers.

### DESCRIPTION OF THE DRAWINGS

FIG. 1 is an isometric view of a reader apparatus for use with a microfluidic cartridge.

FIG. 2 is a side view of an example clip for use as a valve actuator for a microfluidic cartridge.

FIG. 3A is a front view of a portion of an example microfluidic cartridge, according to some embodiments, for use with the reader apparatus of FIG. 1.

FIG. 3B is a bottom view of the portion of the microfluidic cartridge of FIG. 3A.

FIG. 3C is a front view of a portion of another example microfluidic cartridge, according to some embodiments, for use with the reader apparatus of FIG. 1.

FIG. 3D is a bottom view of the portion of the microfluidic cartridge of FIG. 3C.

FIG. 4 is an exploded view of an example microfluidic cartridge, according to some embodiments, for use with the reader apparatus of FIG. 1.

FIG. 5 is an isometric view of the microfluidic cartridge of FIG. 4 in an assembled configuration.

FIG. 6 is an isometric view of the microfluidic cartridge of FIG. 5 with a top cover rendered transparent to reveal the internal fluid pathways.

FIG. 7A is a top-down view of a base of a reader apparatus comprising a microfluidic cartridge with a clip oriented in a first, or open position, and a cross-sectional view of the microfluidic cartridge and the clip.

FIG. 7B is a top-down view of the base of the reader apparatus comprising the microfluidic cartridge with the clip oriented in a second, or installed position, and a cross-sectional view of the microfluidic cartridge and the clip.

FIGS. 8A and 8B are views associated with an example method of using the reader apparatus of FIG. 1.

FIG. 9 illustrates a flow sequence of an example method of forming solidified reagents for use with the microfluidic cartridge of FIG. 1.

FIGS. 10A and 10B illustrate example solidified reagents that can be created using the method of FIG. 9.

FIGS. 11A-11E illustrate a flow sequence of example steps of a rehydration process using solidified reagents created using the method of FIG. 9 installed in a microfluidic cartridge.

### DETAILED DESCRIPTION

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from previous embodiments. Thus, present embodiments are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of disclosed embodiments. Skilled artisans will recognize the examples provided herein have many useful alternatives and fall within the scope of embodiments of this disclosure.

Some embodiments provide point-of-care devices including a reader apparatus comprising a reader and a reader base for use with a microfluidic cartridge that receives a fluid sample. A clip may be slidable along the base and may act as a user-actuated valve actuator to selectively direct the fluid sample within the microfluidic cartridge. After the fluid sample is processed within the microfluidic cartridge, the cartridge may be inserted into the reader for sample analysis. The reader apparatus can further include a display that indicates to a user the results of the analysis. The fluid sample may be processed using solidified reagents, formed using a reagent mold, and rehydrated within the microfluidic cartridge.

Accordingly, embodiments herein describe the designs, fabrication of, and methods of use for point-of-care devices such as a reader apparatus, a reader base, a clip, and/or a microfluidic cartridge, as well as solidified reagents for use with such microfluidic cartridges and reagent molds used for forming the solidified reagents. Furthermore, it should be noted that the designs and methods described herein may also be applied to point-of-care devices fabricated through other techniques.

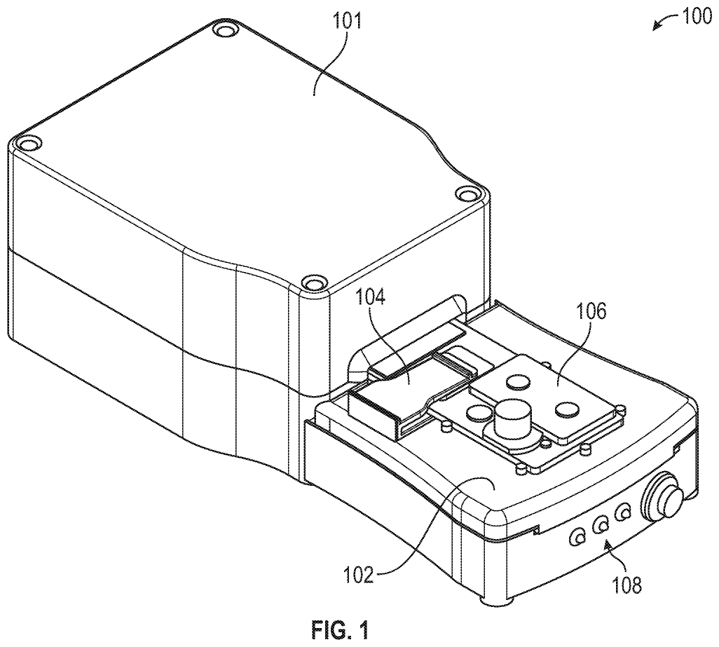

Referring now to FIG. 1, an example reader apparatus 100, according to some embodiments, is illustrated. The reader apparatus 100 includes a reader 101 and a base 102 removably coupled to the reader 101. In some embodiments, the base 102 may be slidably received within a corresponding receptacle or slot of the reader 101. In some embodiments, the base 102 may be magnetically coupled to the reader 101 using one or more magnets that provide secure attachment while permitting tool-free separation. In other embodiments, the base 102 may be snap-fit to the reader 101 using interlocking features that engage with an audible click to confirm proper seating. Additionally, the base 102 may be releasably attached to the reader 101 using latches, clips, friction-fit connections, or other mechanical fastening mechanisms that allow for repeated attachment and detachment without degradation of the coupling interface.

A valve actuation mechanism configured as a clip 104 is positioned on the base 102 and is operable by a user to process a fluid sample from a patient within a microfluidic cartridge 106. The microfluidic cartridge 106 is configured to receive and contain the fluid sample from the patient and serves as the primary sample containment and processing component of the reader apparatus 100. As will be further detailed below, the microfluidic cartridge 106 includes internal channels, reservoirs, and valve structures that allow for sample preparation, purification, and amplification within a single integrated device.

During use, the microfluidic cartridge 106 can be installed on the base 102, which can subsequently be coupled to the reader 101 to analyze the processed sample within the microfluidic cartridge 106. Processing of the fluid sample within the microfluidic cartridge 106 can be achieved using the clip 104 that is slidably received across the microfluidic cartridge 106. The clip 104 is movable between at least two positions, including an open position (e.g., first position) and an installed position (e.g., second position), to direct fluid to different regions of the microfluidic cartridge 106.

To facilitate this fluid direction, the microfluidic cartridge 106 includes valve components that cooperate with the clip 104 to selectively open and close fluid passageways, directing the fluid sample between different functional regions such as a waste reservoir and one or more reaction chambers. By providing valve actuation through manual user operation, the clip 104 eliminates the need for electrical, mechanical, or pneumatic actuation systems, thereby simplifying the overall design, reducing manufacturing costs, and minimizing potential points of failure, although it should be understood that in other embodiments the clip 104 can be actuated through electrical, mechanical, or pneumatic actuation systems. Correspondingly, the sliding mechanism of the clip 104 allows for intuitive operation, as a user can transition between valve positions with a single linear motion rather than requiring complex multi-step manipulations. This sliding action also provides consistent and repeatable valve actuation, ensuring reliable fluid routing throughout the diagnostic process. In this example, the microfluidic cartridge 106 is sealed and self-contained, allowing the reader apparatus 100 (e.g., the reader 101, the base 102, and the clip 104) to be used without cleaning between uses and without risk of cross-contamination. The sealed configuration of the cartridge 106 can also ensure that biohazardous samples remain fully contained within the cartridge 106 throughout the diagnostic process.

In addition to the sealed and self-contained configuration of the microfluidic cartridge 106, the base 102 further contributes to the reliability and ease of use of the reader apparatus 100 by providing structural support and alignment functionality. More specifically, the base 102 supports and positions the microfluidic cartridge 106 during sample processing operations, ensuring proper engagement between the clip 104 and the valve components of the microfluidic cartridge 106. In some examples, the base 102 may include guide rails, recesses, or other alignment features that receive the microfluidic cartridge 106 in a predetermined orientation, thereby preventing misalignment that could compromise valve actuation or fluid flow. In some embodiments, the base 102 may include registration pins that engage corresponding alignment holes or recesses in the microfluidic cartridge 106, thereby aligning and keeping the cartridge 106 level during processing operations. Additionally, the base 102 can facilitate proper insertion of the microfluidic cartridge 106 into the reader 101 for sample analysis by maintaining the cartridge 106 in a fixed position relative to the reader 101 during the coupling process.

The reader apparatus 100 can further include a display 108 that provides a visual indication to the user of the results of the analysis. For example, the display 108 can include colored lights or other visual indicators corresponding to positive or negative detection of a target substance, such as a red light indicating positive detection and a green light indicating negative detection. In some embodiments, the display 108 can provide alphanumeric readouts, graphical representations of test results, or quantitative measurements such as fluorescence intensity values. In other embodiments, the display 108 can be configured to provide auditory indicators, such as tones or spoken alerts, in addition to or in place of visual indicators. Furthermore, in some embodiments, the reader apparatus 100 can be configured to communicate with an external device, such as a smartphone, tablet, or computer system, via a wired connection, such as USB, Ethernet, or serial interface, or wirelessly, to transmit test results as push notifications, display detailed analysis data, or allow for remote monitoring and data logging, although other configurations are possible.

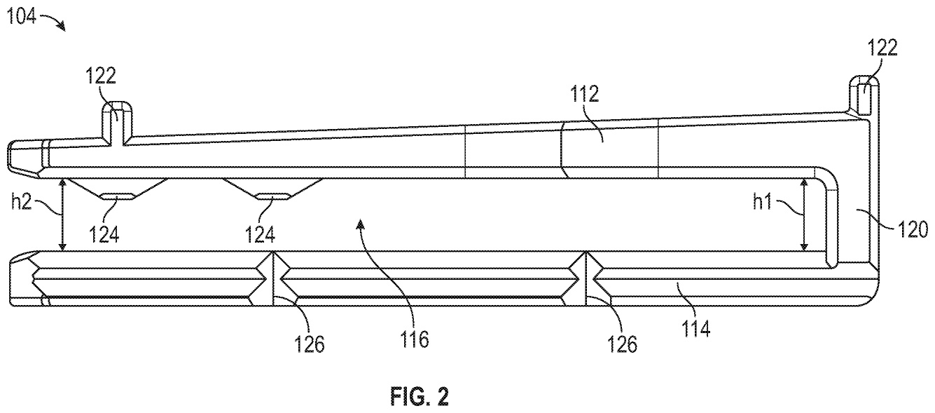

Referring now to FIG. 2, an example of the clip 104 is illustrated. As shown, the clip 104 includes a top extension 112 and a bottom extension 114 that together define a channel 116 therebetween. The channel 116 is configured to receive and securely retain the microfluidic cartridge 106 during fluid processing operations. A support 120 connects the top extension 112 and the bottom extension 114 at one end of the clip 104, thereby enclosing the channel 116 on three sides while leaving an opposite end open for cartridge insertion. In this embodiment, the clip 104 is configured as a spring clip that utilizes inherent spring tension generated by the resilient material of the clip 104 to maintain secure engagement with the cartridge 106 without requiring additional fastening mechanisms such as screws, latches, or adhesives. This spring-loaded configuration allows the clip 104 to apply consistent compressive pressure against opposing surfaces of the cartridge 106, ensuring reliable and repeatable valve actuation throughout fluid processing operations. The spring tension also accommodates for minor variations in cartridge thickness while maintaining sufficient pressure for effective cartridge 106 engagement. In some embodiments, the support 120 is positioned to contact an edge of the cartridge 106 when the clip 104 reaches a fully installed position, thereby providing visual and tactile feedback to a user that confirms proper alignment and complete seating of the cartridge 106 within the clip 104.

To facilitate user manipulation of the clip 104, the top extension 112 of the clip 104 can include grips 122 or other protrusions that allow a user to easily grasp and manipulate the clip 104 during operation. In this example, the grips 122 extend upwardly from the top extension 112 and provide raised surfaces against which a user can apply lateral force to slide the clip 104 relative to the cartridge 106. In some embodiments, the grips 122 may be integrally formed with the clip 104 during manufacturing and made of the same material as the clip 104. In other embodiments, the grips 122 can be formed separately and attached to the clip 104, and may be made of a rubber, silicone, or other elastomeric material that provides enhanced friction and prevents slipping between a user's fingers during operation. In some embodiments, the grips 122 may include textured surfaces such as knurling, cross-hatching, or raised dots, as well as ridges or other ergonomic contours that further improve grip security and tactile feedback during manipulation. Accordingly, a user may press against the grips 122 with one or more fingers, such as a thumb and forefinger, to slide the clip 104 back or forth relative to the cartridge 106, thereby actuating the valve components and selectively directing fluid flow within the cartridge 106 as described herein.

Furthermore, as shown in FIG. 2, the top extension 112 of the clip 104 can include one or more protrusions or bumps 124 that extend downwardly from an interior surface of the top extension 112 into the channel 116 toward the bottom extension 114. In this example, the bumps 124 are configured to serve as valve actuating elements that interact with corresponding valve structures on the cartridge 106. In particular, the bumps 124 are configured to align with corresponding valve holes on the cartridge 106 when the clip 104 is positioned over the cartridge 106. For example, when a bump 124 is aligned with a corresponding valve hole, the bump 124 is configured to apply localized downward pressure onto the cartridge 106 due to the inherent spring forces generated by the resilient material of the clip 104. In this way, as will be further detailed below, the bumps 124 are configured to selectively open or close valves on the cartridge 106 based on the lateral position of the clip 104 relative to the cartridge 106.

In the illustrated example, two bumps 124 are shown extending into the channel 116. However, in other embodiments, more or fewer bumps 124 can be included such that the number of bumps 124 corresponds with the number of valve holes or fluid channels requiring actuation on a particular cartridge design. Accordingly, the clip 104 can simultaneously engage and actuate multiple valves at the same time with a single sliding motion. In this example, the clip 104 may be compatible with various types of lab-on-a-chip devices or cartridges that incorporate press-actuated valves, providing a versatile and adaptable valve actuation mechanism suitable for a wide range of diagnostic applications. Furthermore, in some embodiments, the clip 104 may be designed with a stronger spring force such that the bumps 124 are omitted entirely and the top extension 112 of the clip 104 directly applies sufficient distributed pressure onto the cartridge 106 to actuate the valves, although other configurations are possible.

In some embodiments, each bump 124 can be tapered such that a diameter of the bump 124 at a proximal end (e.g., connected to the top extension 112 of the clip 104) is between about 3 millimeters and about 6 millimeters, or between about 4 millimeters and about 5 millimeters, or about 4.3 millimeters. The diameter of the bump 124 at a distal end (e.g., that extends fully into the channel 116) is between about 0.5 millimeters and about 2 millimeters, or between about 0.6 millimeters and about 1.2 millimeters, or about 0.8 millimeters. In this way, the bumps 124, and the clip 104 itself, can be expanded in size by width or length that allows the clip 104 to be useable with different cartridge 106 sizes.

Furthermore, in some embodiments, the bottom extension 114 of the clip 104 can include one or more detents 126 that extend downwardly from the bottom extension 114 of the clip 104. In this example, the detents 126 are configured to engage corresponding features on the base 102 as the clip 104 is slidably moved along the base 102 during valve actuation operations. More specifically, the detents 126 are positioned to click into place with complementary recesses, ridges, grooves, or other engagement features formed in the base 102, thereby providing tactile and, in some cases, audible feedback to a user that confirms when the clip 104 has reached a particular position, such as the open position or the installed position. This feedback mechanism allows users to reliably and repeatably position the clip 104 at predetermined locations without requiring visual confirmation of clip placement, which can be particularly advantageous in low-light conditions, when the user's attention is directed elsewhere, or when the user has limited dexterity. The detent engagement also helps maintain the clip 104 in the desired position during subsequent fluid processing steps, resisting inadvertent displacement caused by vibration, handling, or other external forces. In some embodiments, the cartridge 106 itself may include embedded alignment registrations, such as molded recesses or raised features, that engage directly with the detents 126 to provide positional feedback to the user. In such embodiments, the clip 104 may be adjusted relative to the cartridge 106 independently of the base 102, allowing for standalone operation of the clip 104 and cartridge 106 assembly without requiring the base 102 to be present during valve actuation.

As further shown in FIG. 2, the clip 104 and, more specifically, the channel 116 can include a height that tapers along its length from the support 120 toward an opening of the channel 116. In particular, a first height h1 measured adjacent the support 120 is greater than a second height h2 measured adjacent the opening of the channel 116. This tapered configuration provides clamping force as the cartridge 106 is inserted further within the channel 116, thereby securing the cartridge 106 during installation. Additionally, this tapered design allows the clip 104 to accommodate variations in fluid pressure within the cartridge 106 during sample processing. For example, if elevated fluid pressure generated during syringe actuation causes the cartridge 106 to expand slightly, the resilient material of the clip 104 permits the top extension 112 to flex relative to the bottom extension 114, thereby temporarily increasing the channel height and preventing damage to the cartridge 106 or disruption of the sealed fluid pathways while maintaining secure engagement. In this manner, the tapered channel 116 can provide both reliable cartridge retention during normal operation and resilience against pressure fluctuations during fluid processing operations, as will be further detailed below.

In some examples, the clip 104 measures between about 30 millimeters and about 40 millimeters in length, between about 35 millimeters and about 38 millimeters in length, or about 36 millimeters in length. The clip 104 also measures between about 15 millimeters and about 25 millimeters wide, or between about 18 millimeters and about 22 millimeters wide, or about 20 millimeters wide. The clip 104 also measures between about 5 millimeters and about 10 millimeters high, or between about 6 millimeters and about 9 millimeters high, or about 7.5 millimeters high. However, in other examples, the clip 104 may take on other dimensions to accommodate different cartridge sizes or applications.

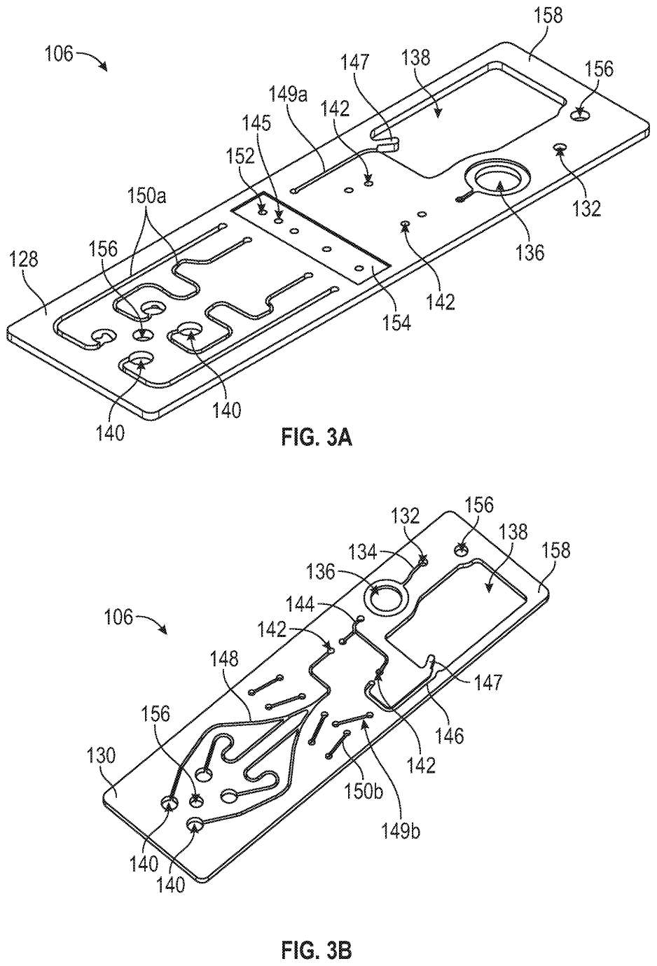

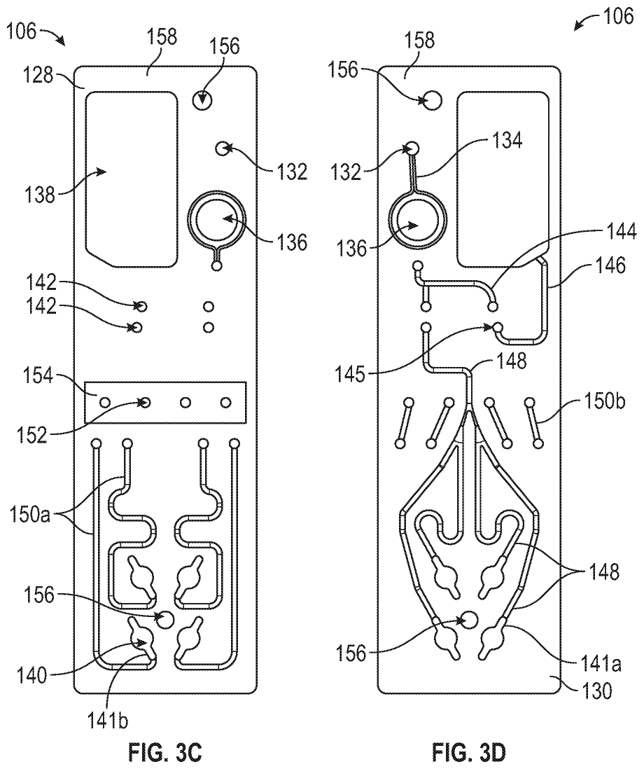

Referring now to FIGS. 3A and 3B, as well as FIGS. 3C and 3D, a top side 128 and a bottom side 130, respectively, of a main component 158 of the cartridge 106 are illustrated. FIGS. 3A and 3B illustrate a first embodiment of the main component 158, while FIGS. 3C and 3D illustrate a second embodiment that shares similar structural and functional features. Corresponding elements in FIGS. 3C and 3D are identified using the same reference numerals as in FIGS. 3A and 3B. The following description refers primarily to FIGS. 3A and 3B, but applies equally to FIGS. 3C and 3D unless otherwise noted. In the examples of FIGS. 3A-3D, the main component 158 contains the various channels, cavities, and reservoirs that facilitate fluid processing of the cartridge 106. In particular, as shown in FIG. 3A, the cartridge 106 includes an input hole 132 that provides an entry point for receiving a fluid sample from a syringe or other sample delivery mechanism. An input channel 134 (FIG. 3B) extends from the input hole 132 and fluidly (i.e., fluidically) connects the input hole 132 to a silica membrane cavity 136, thereby establishing a fluid pathway for sample introduction into the cartridge 106.

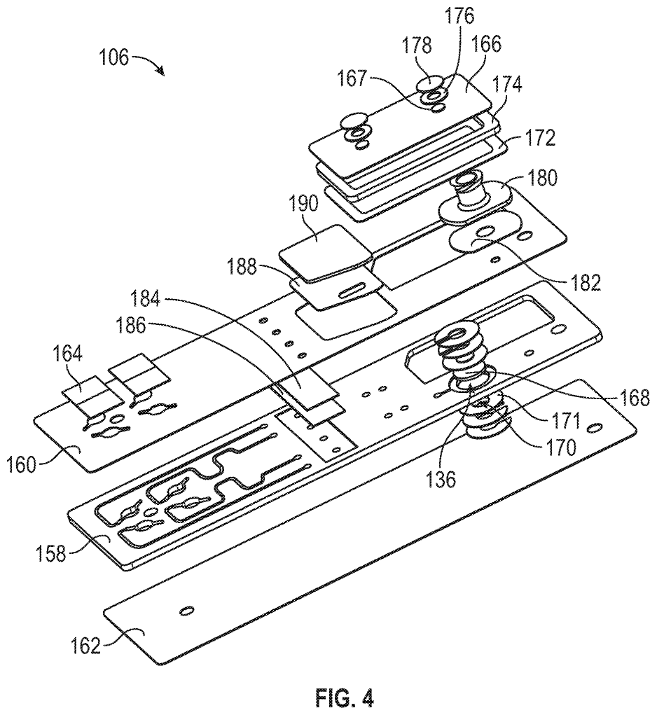

In this example, the silica membrane cavity 136 is configured to receive and retain a silica membrane 168 (shown in FIGS. 4-6), which functions as a nucleic acid capture and purification element within the cartridge 106. In some embodiments, the silica membrane 168 comprises a silica matrix harvested from a commercial spin column, such as a Zymo-Spin III column, that filters, separates, and purifies nucleic acids from fluid samples passing through the cartridge 106, although other configurations are possible. In other embodiments, the silica membrane cavity 136 can accommodate alternative nucleic acid binding materials, including but not limited to silica matrices, glass fiber membranes, magnetic beads, silica beads, or other suitable nucleic acid binding substrates.

During operation, nucleic acids present in the fluid sample bind to the silica membrane 168 as the sample passes through the silica membrane cavity 136, thereby allowing collection and concentration of the nucleic acids for subsequent processing and analysis. This binding mechanism eliminates the need for centrifugation during sample preparation. In particular, this binding mechanism relies on chaotropic salts present in the sample buffer that disrupt hydrogen bonding between water molecules and nucleic acids, promoting adsorption of the nucleic acids onto the silica surface. As such, no centrifuging is necessary for sample preparation, which simplifies the workflow and eliminates the need for laboratory equipment that would otherwise be required for conventional nucleic acid extraction protocols. In embodiments utilizing glass fiber, the binding material can provide increased surface area for nucleic acid capture, which may be advantageous for samples with low nucleic acid concentrations. In embodiments where magnetic beads are utilized as the nucleic acid binding material, the base 102 can include a corresponding magnet positioned to align with the silica membrane cavity 136 when the cartridge 106 is installed on the base 102, such that the magnetic field generated by the magnet maintains the magnetic beads in a fixed position within the silica membrane cavity 136 during fluid movement, thereby preventing bead displacement and ensuring consistent nucleic acid capture efficiency.

The cartridge 106 further includes a waste reservoir 138 (FIG. 3A) and one or more reaction chambers 140 (FIG. 3A) that receive fluid samples based on the position of the clip 104. In this example, each reaction chamber 140 can be configured as a cavity to receive a reagent with which a sample may react upon entering the reaction chamber 140 (and, as further described below, the reader 101 can be used to analyze this reaction). As noted above, during operation, the clip 104 serves as a user-actuated valve actuator that controls fluid routing within the cartridge 106 depending on the lateral position of the clip 104. For example, when the clip 104 is positioned in a first configuration (e.g., the open position), fluid is directed along a first flow path toward the waste reservoir 138, allowing sample fluid, wash buffers, and other waste materials to be collected and contained within the waste reservoir 138 during sample processing. Conversely, when the clip 104 is positioned to a second configuration (e.g., the installed position), fluid is directed along a second flow path toward the reaction chambers 140, allowing processed samples to reach the reaction chambers 140 for subsequent analysis. As such, in some embodiments, the reaction chambers 140 are configured to receive purified sample material for analysis and can contain pre-loaded reagents for nucleic acid amplification or other diagnostic reactions.

To achieve this selective fluid routing via the clip 104 positioning, pairs of spaced-apart valve holes 142 are positioned within the main component 158 of the cartridge 106. In this example, the valve holes 142 are configured to be either in fluid communication with or blocked from fluid communication depending on the position of the clip 104 relative to the cartridge 106. Each pair of valve holes 142 traverses through the main component 158, with fluid entering through a valve hole 142 on one side of the main component 158, traveling through an associated channel, and exiting through a corresponding valve hole 142 on the opposite side. In some embodiments, the valve holes 142 may be actuated using alternative mechanisms, such as padding screws positioned directly above the valve holes 142 that are manually screwed or unscrewed to compress or release the valve rubber 190, solenoid-based valves that use pneumatic pressure to actuate the valve elements, or direct finger pressure applied by a user. Alternatively, in some embodiments, the valve actuation of the valve holes 142 may be automated using solenoids controlled by software or a programmable controller, although other configurations are possible.

Continuing with the example shown in FIGS. 3A and 3B, when the clip 104 is positioned in the first position (e.g., the open position), the bumps 124 of the clip 104 depress into the valve holes 142 associated with the reaction chamber pathway, thereby blocking fluid flow to the reaction chambers 140. In this configuration, fluid received through the input hole 132 is routed through a valve channel 144, across an unobstructed first pair of valve holes 142, and through a waste inlet channel 146 to the waste reservoir 138 (see FIG. 3B).

As shown in FIG. 3A, at the location where the waste exits the waste reservoir 138 (e.g., through a waste vent channel 149a in this example), a tab 147 extends into the waste reservoir 138. In this example, the tab 147 is configured to facilitate venting and relieve trapped air during fluid filling of the waste reservoir 138 that could otherwise impede waste collection, as will be further detailed below. In some embodiments, the tab 147 may be configured with a specific geometry, such as a tapered or angled profile (e.g., relative to the waste reservoir 138), that directs air bubbles toward the waste vent channel 149a, a bottom waste vent channel 149b (FIG. 3B), and a waste vent hole 145 while minimizing disruption to the incoming fluid stream, thereby further enhancing the efficiency of waste collection and ensuring complete filling of the waste reservoir 138 during sample processing operations. This flow path allows initial sample loading and washing operations to direct fluid to the waste reservoir 138 while preventing premature entry of fluid into the waste vent channels 149a, 149b.

More specifically, in this example, the waste reservoir 138 can have the same depth as the main component 158 of the cartridge 106. To conserve space and maintain a compact form factor, the waste vent channel 149a can be positioned adjacent to the tab 147, where fluid enters the waste reservoir 138. To prevent fluid from prematurely reaching the waste vent hole 145 before the waste reservoir 138 is completely filled, the tab 147 directs incoming fluid to flow along the perimeter of the waste reservoir 138 rather than directly toward the waste vent hole 145 (via the waste vent channels 149a, 149b). In the example shown in FIGS. 3A and 3B, fluid entering the waste reservoir 138 can fill in a clockwise pattern around the perimeter of the waste reservoir 138 until the reservoir 138 is sufficiently full to exit through the waste vent hole 145 via the waste vent channels 149a, 149b. In other embodiments, the tab 147 can be configured to direct the fluid to other areas of the cartridge 106. Furthermore, in some embodiments such as that shown in FIGS. 3C and 3D, the waste reservoir 138 may omit the waste vent hole 145, the tab 147, and the waste vent channels 149a, 149b, and instead utilize a more stacked configuration of the waste reservoir 138 that facilitates venting through layering, as will be further detailed below with regard to FIG. 4.

When the clip 104 is moved to the second position (e.g., the installed position), the bumps 124 shift laterally and depress into the valve hole(s) 142 associated with the waste inlet channel 146, thereby blocking fluid flow to the waste reservoir 138. Simultaneously, the valve hole(s) 142 associated with the reaction chamber pathway that were previously depressed by the clip revert to their original uncompressed shape due to its elastic properties, thereby opening the fluid pathway to the reaction chambers 140. In this configuration, fluid received through the input hole 132 is routed through the valve channel 144, across the now-unobstructed second pair of valve holes 142, and through an inlet channel 148 that branches and splits into equidistant channels leading to each of the reaction chambers 140. Accordingly, the coordinated interaction between the clip 104 and the valve holes 142 provides a simple yet effective mechanism for selectively controlling fluid flow within the cartridge 106 through manual user actuation.

Each reaction chamber 140 can be configured as a cavity and can include a reagent, such as lyophilized nucleic acid amplification reagents or primers for specific disease targets, with which a sample may react upon entering the reaction chamber 140 (and, as further described below, the reader 101 can be used to analyze this reaction). The reagents within each reaction chamber 140 can be pre-loaded during cartridge assembly and can be configured to detect different target sequences, allowing the cartridge 106 to be adapted for various diagnostic applications.

As shown in FIGS. 3A-3D, the cartridge 106 can include multiple reaction chambers 140, such as two, three, four, or more reaction chambers 140, allowing for multiplexing of the same sample, increasing efficiency and allowing multiple targets of one disease or multiple disease detections to occur simultaneously. In particular, four reaction chambers 140 may provide an optimal balance between both multiplexing capability and cartridge compactness, allowing for simultaneous detection of multiple disease targets while maintaining a streamlined form factor suitable for point-of-care applications. This multiplexing capability can further reduce the overall testing time and cost per target as compared to running separate individual tests, while also conserving limited sample volumes that may be difficult to obtain from certain patient populations. However, in some embodiments, the cartridge 106 may include a single reaction chamber 140. In some embodiments such as those shown in FIGS. 3C and 3D, the reaction chambers 140 can incorporate a same-depth-inlet-outlet (SDIO) shape that reduces air entrapment and bubble formation during fluid filling, although other shapes are possible. For example, the reaction chambers 140 can include an inlet tab 141a and an outlet tab 141b that extend from each reaction chamber 140 to help with venting and prevent air bubble buildup within the chamber 140 during fluid filling and draining.

Still referring to FIGS. 3A and 3B, the cartridge 106 further includes vent channels configured as a top vent channel 150a (FIG. 3A) and a bottom vent channel 150b (FIG. 3B) that extend from each of the reaction chambers 140 to corresponding vent holes 152 located within a vent recess 154. The vent channels 150a, 150b in this example serve to maintain fluid separation from the inlet channels 148, thereby preventing cross-contamination between the sample delivery pathway and the venting pathway. The vent channels 150a, 150b also provide a pathway for air displacement during fluid filling of the reaction chambers 140, allowing the fluid sample to completely fill each reaction chamber 140 without air pockets that could interfere with the reaction or analysis. During operation, fluid exits the reaction chambers 140, travels through the equidistant vent channels 150a, 150b, traverses through the material of the main cartridge component 158, and is ultimately vented at the vent holes 152. The equidistant configuration of the vent channels 150a, 150b promotes consistent venting behavior and pressure equalization across all reaction chambers 140, which contributes to uniform reaction conditions during sample analysis. This equidistant configuration also helps avoid air trapping within the reaction chambers 140, as compared with non-equidistant channels in other designs that can result in unequal pressure resistance which causes fluid to flow at different rates, potentially trapping air in chambers where fluid arrives more slowly.

Additionally, as shown in FIGS. 3A and 3B, alignment holes 156 are distributed at predetermined locations along the main component 158. The alignment holes 156 serve as registration features that facilitate correct positioning and orientation of the various layers and components during cartridge 106 assembly, as will be further detailed below. More specifically, the alignment holes 156 provide reference points that ensure each layer of the cartridge 106 is accurately positioned relative to adjacent layers, thereby maintaining proper spatial relationships between the channels, cavities, and reservoirs formed within the main component 158. This layer-to-layer alignment maintains proper fluid channel geometry throughout the assembled cartridge 106, as even minor misalignment between layers could result in partial obstruction of fluid pathways, inconsistent channel dimensions, or unintended fluid communication between adjacent channels. Furthermore, the alignment holes 156 help ensure consistent valve operation by maintaining proper positioning of the valve holes 142 relative to the valve channel 144, the waste inlet channel 146, and the inlet channel 148, such that the clip 104 can reliably engage with the valve holes 142 to selectively direct fluid flow as intended.

Referring now to FIG. 4, an exploded view of the cartridge 106 is illustrated, showing the layered construction and arrangement of the various components. In particular, the cartridge 106 includes the main component 158 that is configured as a central structural layer and positioned between a top cover 160 and a bottom cover 162. A reaction chamber cover 164 is positioned over each respective reaction chamber 140 to seal the reaction chambers 140 and prevent fluid leakage or evaporation during sample processing and analysis. Similarly, a waste cover 166 is positioned over the waste reservoir 138 to contain waste fluids generated during sample preparation and washing operations. In this configuration, the top cover 160, the bottom cover 162, the reaction chamber cover 164, and the waste cover 166 collectively enclose the main component 158 of the cartridge 106, thereby fully containing the sample within designated cavities and channels throughout the diagnostic process. This layered enclosure arrangement ensures that biohazardous samples remain sealed within the cartridge 106 and prevents cross-contamination between different functional regions of the cartridge 106. In some embodiments, a pin or other alignment feature may be integrally or otherwise formed within the alignment holes 156 to help align the top cover 160 and the bottom cover 162 with the main component 158 during assembly, although other configurations are possible.

As also shown in FIG. 4, the silica membrane cavity 136 includes the silica membrane 168 along with layers of membrane rings 171 that together form a layered sealing structure around the silica membrane 168 and create a membrane ring channel 170. This layered configuration directs fluid flow through the center of the silica membrane 168 rather than allowing fluid to bypass around the peripheral edges of the membrane 168. More specifically, the membrane rings 171 are configured as annular structures that surround the silica membrane 168 and define the membrane ring channel 170 as a central passage that directs fluid flow perpendicular to the silica membrane 168 surface. This configuration creates a fluid-tight seal that forces the fluid sample to pass directly and uniformly through an active binding region of the silica membrane 168, thereby ensuring effective nucleic acid capture and filtration during sample processing. This directed flow path prevents fluid leakage around the sides of the silica membrane 168, which can occur in conventional designs and result in reduced nucleic acid recovery and compromised assay sensitivity. By channeling all fluid through the active filtration area of the silica membrane 168, the membrane rings 171 maximize nucleic acid binding efficiency and improve overall sample purification performance. In some embodiments, the silica membrane cavity 136 can be injection molded with a depressed perimeter to compliantly seal all the sides of the silica membrane 168 that further prevents fluid bypass around the peripheral edges of the membrane 168, although other configurations are possible. In some applications, the silica membrane cavity 136 can be configured with an increased height to accommodate additional binding material, which may be advantageous for highly sensitive assays requiring enhanced nucleic acid capture capacity. Additionally, in some embodiments, multiple silica membranes 168 can be stacked within the silica membrane cavity 136 to increase the total binding capacity for applications involving larger sample volumes or higher nucleic acid concentrations.

Additionally, the waste reservoir 138 is enclosed by a multi-layer waste assembly comprising the waste cover 166, a waste adhesive 172, a waste acrylic 174, a waste filter adhesive 176, and a waste filter 178. As shown in FIG. 4, the waste filter adhesive 176 secures the waste filter 178 over a waste vent hole 167 formed in the waste cover 166, thereby allowing air to escape from the waste reservoir 138 during fluid filling while preventing liquid from leaking out of the cartridge 106. This stacked configuration of waste components increases the overall depth and capacity of the waste reservoir 138, allowing the waste reservoir 138 to accommodate larger volumes of fluid than would otherwise be possible with a single-layer construction. The increased capacity is particularly advantageous for accommodating both the initial sample fluid and subsequent wash fluids used during sample preparation, thereby minimizing the risk of overflow and reducing potential contamination of other regions of the cartridge 106. Furthermore, in some embodiments, the waste reservoir 138 can be further expanded by adding additional layers or increasing the thickness of the waste acrylic 174 to process higher sample volumes as required by specific diagnostic applications.

A Luer adapter 180 is positioned adjacent to the waste reservoir 138 and provides a standardized connection interface at the input hole 132 for receiving fluid samples into the cartridge 106. The Luer adapter 180 is secured to the main component 158 using a Luer adhesive 182, which creates a fluid-tight seal between the adapter 180 and the cartridge 106. In this example, the Luer adapter 180 is configured to engage with external fluid delivery devices, such as syringes equipped with Luer lock or Luer slip fittings, thereby allowing secure and leak-free attachment during sample loading, washing, and elution operations as further detailed below. In this way, the Luer connection provided using the Luer adapter 180 allows compatibility with commonly available off-the-shelf syringes and medical devices, eliminating the need for specialized or proprietary sample delivery equipment. Other threaded adapters may also be used in some embodiments.

Alternatively, a slip fit connection may be used in place of the Luer lock connection. In this example, the slip fit and similar smooth-fitting attachments may require additional sealing methods to prevent leakage (whereas Luer lock or threaded adapters provide a secure seal without additional accessories).

Furthermore, in other embodiments, a sample collection tube can be directly connected to the cartridge 106 at the input hole 132, bypassing the need for a syringe-based sample delivery mechanism. In such embodiments, the sample collection tube may connect to the input hole 132 through the Luer adapter 180 or through a dedicated tube adapter. The connection may be achieved through friction fit, threaded connections, or snap-fit features. This configuration allows for direct transfer of collected samples into the cartridge 106 without requiring intermediate transfer to a syringe, thereby simplifying the sample handling workflow and reducing potential contamination or sample loss. In some embodiments, the sample collection tube may be squeezed by a user to deliver the sample through the input hole 132.

Still referring to FIG. 4, a vent filter 184 is received within the vent recess 154 and is secured in position using a vent filter adhesive 186. In this example, the vent filter 184 is configured as a hydrophobic filter that permits air to pass through while preventing fluid leakage from the cartridge 106, thereby maintaining sample containment during fluid processing operations. In particular, the hydrophobic properties of the vent filter 184 allow gases to escape from the reaction chambers 140 and vent channels 150a, 150b during sample loading and processing, while simultaneously blocking aqueous fluids from exiting the cartridge 106 through the vent pathway. In some embodiments, the vent filter 184 may be a PTFE membrane filter with a pore size of about 0.22 μm, which provides sufficient air permeability for venting while blocking aqueous fluids from escaping the cartridge 106. In other embodiments, the vent filter 184 may comprise other hydrophobic materials such as polyvinylidene fluoride (PVDF) or polypropylene with pore sizes ranging from about 0.1 μm to about 0.5 μm depending on the application requirements.

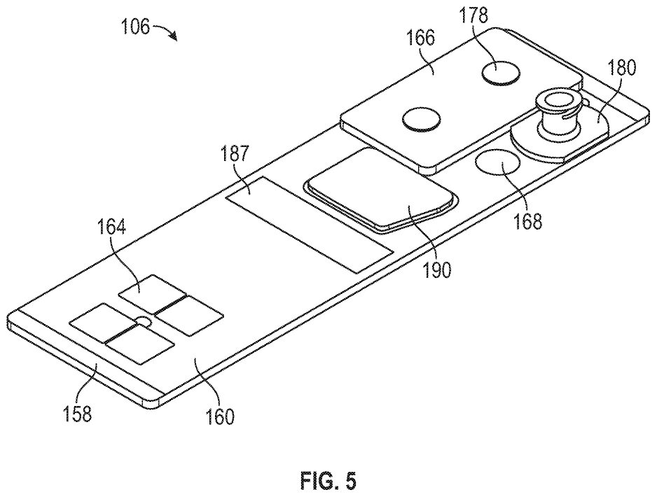

In this example, the vent filter 184 can also serve as a fill indicator to a user by providing tactile feedback. In particular, when fluid completely fills the reaction chambers 140 and contacts the hydrophobic vent filter 184, the liquid is blocked from passing through, resulting in a noticeable increase in resistance at the syringe secured onto the input hole 132 that signals to the user that filling is complete. Additionally, a vent cover 187 (shown in FIG. 5) can be applied over the vent filter 184 prior to heating of the cartridge 106 to prevent evaporation of the sample during thermal amplification operations, thereby maintaining consistent sample volumes within the reaction chambers 140 throughout the diagnostic process.

Additionally, a valve adhesive 188 is applied to the main cartridge component 158 surrounding the valve holes 142. A flexible valve element configured as a valve elastomer or valve rubber 190 is positioned over the valve adhesive 188 and is configured to engage with the clip 104 when the clip 104 is installed on the cartridge 106. In particular, during operation, the valve rubber 190 functions as a deformable sealing element that can be selectively pressed into the valve holes 142 by the bumps 124 of the clip 104, thereby blocking fluid flow through the corresponding valve holes 142 as described above. When the clip 104 is repositioned and the bumps 124 are no longer aligned with a particular valve hole 142, the elastic properties of the valve rubber 190 cause the valve rubber 190 to return to its original uncompressed configuration, thereby reopening the fluid pathway through that valve hole 142.

In some embodiments, the valve adhesive 188 comprises a double-sided silicone pressure sensitive adhesive (PSA), such as 90880, which provides reliable adhesion between the main cartridge component 158 and the valve rubber 190 while maintaining compatibility with the silicone material of the valve rubber 190. In some embodiments, the valve rubber 190 comprises a 40 A durometer silicone rubber, such as 1460N11, which provides sufficient flexibility to deform into the valve holes 142 under pressure from the clip 104 while also providing adequate resilience to return to its original shape when the pressure is removed, although other configurations are possible.

The main component 158 of the cartridge 106 can be manufactured from an injection molded acrylic material, such as polymethyl methacrylate (PMMA) or Plexiglas V825, which provides optical clarity for visualization of fluid flow, chemical resistance that ensures compatibility with biological samples and reagents, and dimensional stability that maintains channel geometry throughout use. However, other suitable thermoplastic materials such as cyclic olefin copolymer (COC), polycarbonate (PC), or polystyrene (PS) may be used depending on the application requirements.

Furthermore, the top cover 160 and/or the bottom cover 162 can be clear or transparent, thereby allowing the reader 101 to detect fluorescence within the reaction chambers 140. This optical transparency allows real-time monitoring of nucleic acid amplification reactions without requiring physical access to the reaction chambers 140, which maintains the sealed and contamination-free environment of the cartridge 106 throughout the diagnostic process. This optical clarity of the covers 160, 162, 164 with low autofluorescence properties can also help maximize signal-to-noise ratio during fluorescence detection. In addition to fluorescence detection, the transparent cover 160, 162, 164 can also allow for other visual detection methods, such as colorimetric detection or turbidity detection, depending on the assay requirements, although other configurations are possible. In some embodiments, the main cartridge component 158 can comprise a deep black coloring and can be manufactured without mold release agents to reduce the effects of autofluorescence and assay inhibition that may otherwise impact reader results, although other configurations are possible. The injection molding process allows the channels, cavities, and reservoirs to be integrally formed within both the top surface and the bottom surface of the main component 158 in a single manufacturing step, as illustrated in FIGS. 3A and 3B.

The cartridge 106 can be assembled using a lamination process that sequentially bonds the main component 158 with the various covers and adhesive layers to form an integrated, sealed cartridge 106. In particular, the cartridge 106 can be designed with scaled manufacturing, utilizing transferable assembly techniques such as injection molding, die cutting, and lamination that facilitate high-volume production. During lamination, each layer is aligned using the alignment holes 156 and bonded under controlled pressure conditions to ensure proper adhesion and to maintain fluid-tight seals between adjacent layers. The sequential bonding process allows for the incorporation of functional elements, such as the silica membrane 168, lyophilized reagents, and filters, at appropriate stages of assembly before subsequent layers are applied.

To seal the channels and the reservoirs and maintain fluid-tight integrity throughout the cartridge 106, various adhesive materials are employed. For example, the bottom cover 162, the top cover 160, the reaction chamber cover 164, the waste cover 166, the vent cover 187, and the membrane rings 171 can each comprise single-sided silicone pressure sensitive adhesive (PSA) tapes, such as Adhesives Research 94090 or equivalent biocompatible silicone adhesives, which provide reliable bonding while maintaining low autofluorescence and chemical resistance suitable for diagnostic applications.

In contrast, the vent filter adhesive 186, the waste filter adhesive 176, the waste adhesive 172, and the Luer adhesive 182 can comprise double-sided acrylic adhesives tapes, such as 3M 300LSE or equivalent high-strength acrylic transfer adhesives, which provide robust bonding between rigid components and ensure secure attachment of filters, adapters, and structural elements to the main component 158. In this example, the waste acrylic 174 can comprise a cast acrylic sheet, such as a 3 millimeter thick black cast acrylic (e.g., McMaster-Carr 8505K741 or equivalent), which provides structural rigidity for the expanded waste reservoir 138 while the black coloring minimizes optical interference during fluorescence detection. However, other adhesive formulations, thicknesses, and material configurations are possible depending on the specific application requirements and manufacturing considerations.

In some embodiments, the various adhesive layers are cut using a cutting plotter, which provides precise dimensional control for the pressure sensitive adhesive materials. A CO₂ laser cutter can also be used to cut the filters and cast acrylic components, as the laser provides clean edges and accurate geometries suitable for these materials. The silicone rubber, such as the valve rubber 190, may be cut using a paper cutter or similar blade-based cutting tool to achieve the desired shape without thermal damage to the elastomeric material, although other cutting methods and configurations are possible depending on manufacturing requirements and material specifications.

During assembly, the silica membrane cavity 136, the silica membrane 168, and the membrane rings 171 are first assembled and sequentially positioned. More specifically, the silica membrane 168 is harvested from a commercial spin column, such as a Zymo-Spin III column as noted above, and is split in half along its height to reduce the overall thickness of the membrane and thereby accommodate the slim profile of the cartridge 106. The vent filter 184 is then applied to the vent recess 154 using the vent filter adhesive 186 to prevent fluid leakage while permitting air venting. The top cover 160 and the bottom cover 162 are then secured to opposing surfaces of the main component 158 to enclose the internal channels and reservoirs.

During this stage of assembly, the reaction chambers 140 are temporarily covered with a medium tack dicing tape (not shown) that provides a removable protective barrier while permitting subsequent access to the reaction chambers 140. This temporary dicing tape is later removed to allow insertion of lyophilized reagents, such as nucleic acid amplification reagents and disease-specific primers, into the reaction chambers 140. In some embodiments, the lyophilized reagents may be prepared using a lactose solution or other sugar solution as a stabilizing excipient, which helps preserve reagent activity during storage at room temperature and eliminates cold chain dependency for transport and storage of the cartridge 106, although other configurations are possible. Once the lyophilized reagents are deposited, the reaction chambers 140 are permanently sealed with the reaction chamber cover 164, which is configured as a single-sided silicone pressure sensitive adhesive (PSA) tape that provides a fluid-tight seal while maintaining optical clarity for fluorescence detection, although other configurations are possible.

After the reaction chamber cover 164 is secured, or alternatively while the reaction chambers 140 remain temporarily covered with the dicing tape, the cartridge 106 is positioned between aluminum plates with rubber backing and compressed using an arbor press with 2000-pound capacity. This pressing operation ensures uniform adhesion across all bonded interfaces and establishes fluid-tight seals between the various layers of the cartridge 106.

Referring still to the assembly process, the expanded waste components are made by layering the waste acrylic 174 with the waste cover 166 to create an enlarged fluid containment volume. The waste vent holes 167 formed within the waste cover 166 are subsequently covered by the waste filter 178, which is secured in position using the waste filter adhesive 176. The assembled waste components, including the waste acrylic 174, the waste cover 166, the waste filter adhesive 176, and the waste filter 178, are then bonded to the main component 158 of the cartridge 106 using the waste adhesive 172. To ensure uniform and secure adhesion across all bonded interfaces, the cartridge 106 with the attached waste stack is placed into an arbor press, which applies consistent compressive force to establish fluid-tight seals between the layered components. In other embodiments, the expanded waste stack can be injection molded as a unitary structure and integrally embedded with the main component 158 in some embodiments, thereby reducing the number of discrete components and assembly steps required during cartridge fabrication, although other configurations are possible.

The Luer adapter 180 is fabricated using stereolithography (SLA) 3D printing with clear resin, which provides the dimensional accuracy and surface finish required for reliable syringe engagement. The Luer adapter 180 is then attached to the cartridge 106 using the Luer adhesive 182, and the cartridge 106 is subsequently placed in the arbor press to ensure proper adhesion and alignment of the Luer adapter 180 with the input hole 132. In other embodiments, the Luer adapter 180 can be injection molded as a separate component or integrally formed with the main component 158 during the injection molding process. Furthermore, the valve rubber 190 is adhered to the main cartridge component 158 using the valve adhesive 188 and is subsequently hand pressed to establish secure contact between the valve rubber 190 and the underlying valve holes 142.

FIG. 5 shows the cartridge 106 in an assembled configuration. In this assembled state, several components extend above the top cover 160 to provide sealing and fluid containment functionality for the main component 158, including the reaction chamber cover 164, the waste cover 166, the waste filter 178, the Luer adapter 180, the vent cover 187, and the valve rubber 190. Together, these components cooperate with the top cover 160 to fully enclose and contain the fluid sample within the channels, cavities, and reservoirs of the main component 158 throughout the diagnostic process.

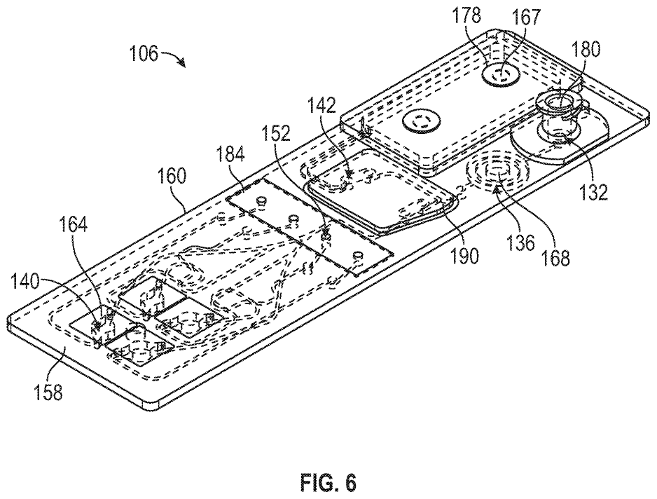

FIG. 6 illustrates the cartridge 106 in the assembled configuration with the top cover 160 rendered transparent to reveal the internal structure of the main component 158. As discussed above, several sealing components cooperate to maintain fluid containment within the cartridge 106 during sample processing and analysis. In particular, the reaction chamber cover 164 is positioned over the reaction chambers 140, the vent cover 187 covers the vent holes 152, the valve rubber 190 covers the valve holes 142, and the waste filter 178 covers the waste vent holes 167. As further shown in FIG. 6 and noted above, the Luer adapter 180 extends upwardly from the top cover 160 and provides a standardized attachment interface at the input hole 132, allowing secure connection with off-the-shelf Luer lock syringes for sample and reagent delivery.

Accordingly, in some embodiments, the cartridge 106 incorporates a streamlined and scalable architecture that facilitates efficient sample processing while minimizing complexity. In particular, the cartridge 106 features a single sample inlet that is multiplexed to distribute fluid to multiple reaction chambers 140, thereby allowing simultaneous detection of multiple targets or diseases from a single sample without requiring separate sample loading operations for each reaction chamber 140. Sample introduction is further simplified through the use of a standardized Luer lock interface at the input hole 132, which provides secure and leak-free connection with commonly available off-the-shelf syringes, eliminating the need for specialized or proprietary sample delivery equipment.

Additionally, the integrated channel and valve architecture of the cartridge 106 can be configured to direct fluid movement between the various functional regions of the cartridge 106 based solely on user actuation of the clip 104. That is, the channel and valve design allow for fluid flow to the reaction chambers 140 without requiring pneumatic systems or other active fluid handling mechanisms, although it should be understood that in other embodiments actuation may be accomplished through electrical, mechanical, or pneumatic actuation systems. The combination of the valve holes 142, the valve rubber 190, and the clip 104 allows active fluid routing controlled entirely by user actuation, reducing system complexity and cost while maintaining reliable fluid control throughout the sample processing workflow. Correspondingly, the sliding mechanism of the clip 104 to cover valve holes allows for intuitive operation, as a user can transition between valve positions with a single linear motion rather than requiring complex multi-step manipulations. This sliding action also provides consistent and repeatable valve actuation, ensuring reliable fluid routing throughout the diagnostic process.

In some embodiments, the overall cartridge 106 can be between about 120 millimeters and about 130 millimeters long, or between about 122 millimeters and about 125 millimeters long, or about 123 millimeters long. The cartridge 106 can also be between about 30 millimeters and about 40 millimeters wide, or between about 35 millimeters and about 37 millimeters wide, or about 36 millimeters wide. The cartridge 106 can also be between about 1 millimeter and about 4 millimeters high, or between about 0.5 millimeters and about 3 millimeters high, or about 1.8 millimeters high.

The reaction chamber 140 can be between about 2 millimeters and about 8 millimeters in diameter, or between about 3 millimeters and about 5 millimeters in diameter, or about 4 millimeters. The extension features of the reaction chamber are between about 1 millimeter and about 4 millimeters long, or between about 2 millimeters and about 4 millimeters long, or about 2.5 millimeters long. When the cartridge 106 is assembled, the total volume of the reaction chamber 140 can be between about 20 μL and about 30 μL, or between about 25 μL and about 28 μL, or about 27.5 μL.

When the cartridge 106 is assembled, the waste reservoir 138 can hold between about 1 mL and about 5 mL of fluid, or between about 1.5 mL and about 3 mL of fluid, or about 1.8 mL of fluid. The waste inlet channel 146 is between about 0.8 millimeter to about 4 millimeters wide, or between about 1 millimeters to about 3 millimeters wide, or about 1.2 millimeters wide. The waste inlet channel 146 is between about 0.2 millimeters and about 3 millimeters high, or between about 0.5 millimeters and about 2 millimeters high, or about 0.6 millimeters high to allow for fast processing of the sample fluid.

When the cartridge 106 is assembled, the inlet channels 148 can hold between about 30 μL and about 40 μL of fluid, or between about 35 μL and about 38 μL, or about 36 μL of fluid. The inlet channels 148 can be between about 0.4 millimeters and about 2 millimeters wide, or between about 0.5 millimeters and about 1 millimeter wide, or about 0.6 millimeters wide. The inlet channels 148 can be between about 0.2 millimeters and about 1 millimeter high, or about 0.3 millimeters and about 0.8 millimeters high, or about 0.3 millimeters high. The inlet channels 148 can further have a path length of between about 48 millimeters and about 50 millimeters, or between about 49.01 millimeters and between about 49.20 millimeters, or about 49 millimeters. In this example, the width, depth, and thickness of the inlet channels 148 can be configured to provide appropriate flow resistance, which helps prevent the reagents from being displaced from the reaction chambers 140 in cases where a user applies excessive force during syringe actuation. In some embodiments, the vent channels 150a, 150b have smaller width and depth than the inlet channels 148. In other embodiments, the inlet channels 148 have a smaller width than the entrance of the reaction chambers 140.

When the cartridge 106 is assembled, the vent channels 150a, 150b can hold between about 50 μL and about 60 μL of fluid, or between about 52 μL and about 58 μL of fluid, or about 54 μL of fluid, including the vent holes 152 and the vent channels 150a, 150b. The vent channels 150a, 150b can be between about 0.4 millimeters and about 2 millimeters wide, or between about 0.5 millimeters and about 1 millimeter wide, or about 0.6 millimeters wide. The vent channels 150a, 150b can be between about 0.1 millimeters and about 1 millimeter high, or about 0.2 millimeters and about 0.8 millimeters high, or about 0.2 millimeters high. Furthermore, the top vent channel 150a can have a path length of between about 25 millimeters and about 27 millimeters, or between about 26.00 millimeters and about 26.05 millimeters, or about 26 millimeters. Correspondingly, the bottom vent channel 150b can have a path length of between about 6 millimeters and about 8 millimeters, or between about 6.50 millimeters and about 7.23 millimeters, or about 7 millimeters. In this example, the vent channels 150a, 150b can be configured with a width that is smaller than the reaction chambers 140, which helps prevent the pre-loaded reagent from being pushed out of the reaction chambers 140 or venting excessively through the vent channels 150a, 150b during fluid delivery.

The silica membrane cavity 136 can have a diameter between about 5 millimeters and about 10 millimeters, or between about 6 millimeters and about 9 millimeters, or about 7.7 millimeters, although other configurations are possible.

The vent recess 154 can have a depth of between about 0.2 millimeters and about 2 millimeters, or between about 0.3 millimeters and about 1 millimeter, or about 0.35 millimeters to hold the vent filter 184 (e.g., having the hydrophobic filter) that prevents leakage.

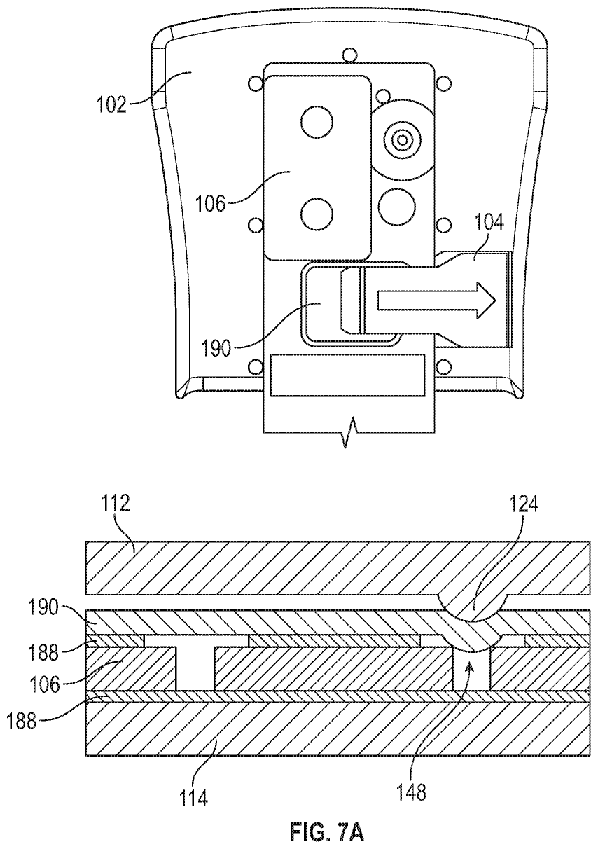

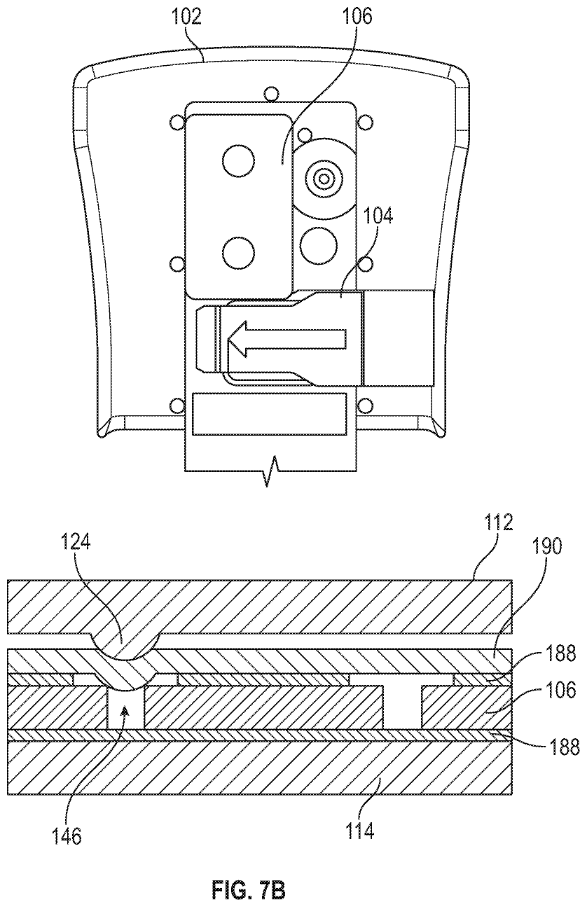

Referring now to FIGS. 7A and 7B, the clip 104 is shown in the open position and the installed position, respectively. As shown in FIG. 7A, the cartridge 106 is received within the channel 116 of the clip 104 such that the bumps 124 extending from the top extension 112 are aligned with the valve rubber 190 covering the valve holes 142. In the open position, the bump 124 depresses the valve rubber 190 into a valve hole 142 associated with the reaction chamber pathway (e.g., an elution hole), thereby blocking fluid flow through the inlet channel 148 and directing fluid introduced through the input hole 132 toward the waste reservoir 138 during initial sample loading and washing operations via the waste channel 146. The spring tension inherent in the clip 104 maintains consistent downward pressure on the valve rubber 190, ensuring reliable occlusion of the valve hole 142 throughout the sample loading and washing phases without requiring the user to maintain manual pressure on the clip 104. The elastic nature of the valve rubber 190 allows the valve rubber 190 to deform into the valve holes 142 when engaged by the bump 124, creating a fluid-tight seal that prevents fluid from passing through the blocked valve hole 142 and directing fluid flow exclusively through the unblocked pathway.

Conversely, when the clip 104 is moved to the installed position as shown in FIG. 7B, the bump 124 depresses the valve rubber 190 into a valve hole 142 associated with the waste pathway (e.g., a waste hole), thereby blocking fluid communication through the waste channel 146 and directing fluid toward the reaction chambers 140 via the inlet channel 148. The lateral displacement of the clip 104 between the open position and the installed position simultaneously closes one fluid pathway while opening another, thereby providing coordinated valve actuation through a single user-initiated sliding motion. That is, when the clip 104 is repositioned such that the bump 124 no longer aligns with a particular valve hole 142, the valve rubber 190 reverts to its original shape, allowing fluid to flow through that valve hole 142. This reversible deformation allows for repeated actuation cycles without degradation of valve performance, allowing the clip 104 to be moved between positions multiple times during a single sample processing procedure.

As noted above, the detents 126 extending from the bottom extension 114 of the clip 104 engage corresponding features on the base 102 as the clip 104 is slidably moved, providing tactile feedback to confirm when the bumps 124 are properly aligned with the valve holes 142 associated with either the waste channel 146 or the inlet channel 148.

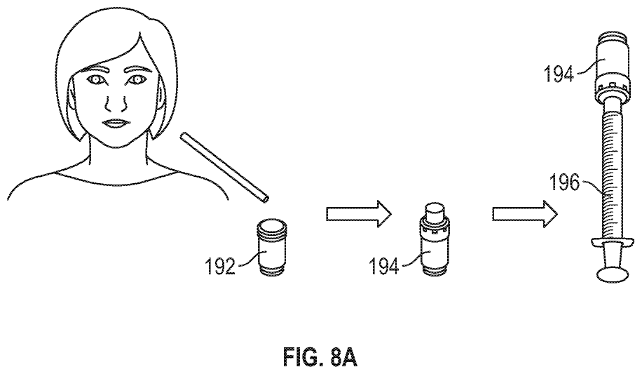

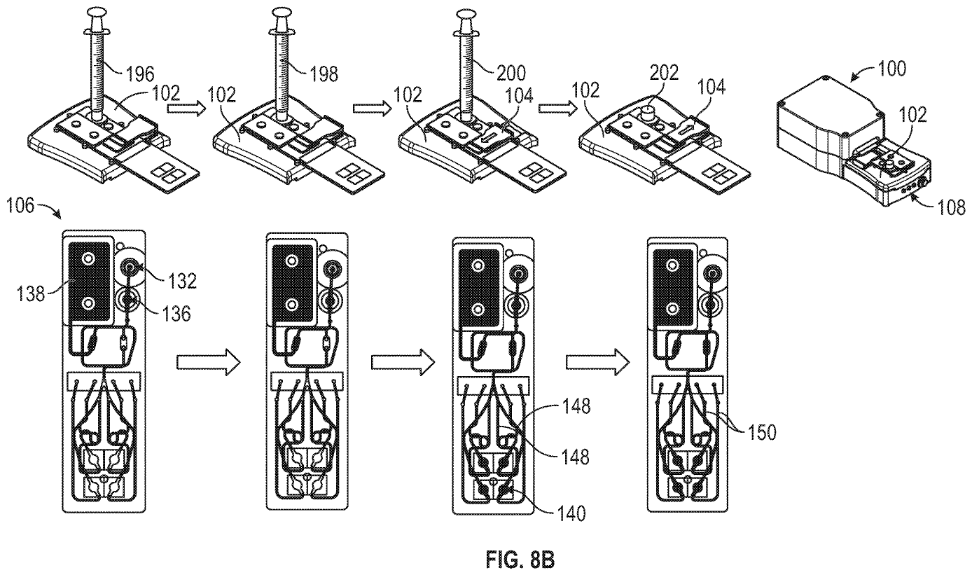

Referring now to FIGS. 8A and 8B, an example method of using the reader apparatus 100 and the clip 104 is illustrated. As shown in FIG. 8A, the method begins with collecting a sample 192 from a patient. The sample 192 may comprise various biological fluids or materials, including but not limited to saliva, cervical fluid, skin lesion swabs, blood, urine, nasal swabs, or other clinically relevant specimens. In some embodiments, the cartridge 106 can be configured for viral detection such as human papillomavirus (HPV) or monkeypox virus (MPXV) for DNA detection, severe acute respiratory syndrome coronavirus 2 (SARS-CoV-2) or respiratory syncytial virus (RSV) for RNA detection, and beta-actin (ACTB) as a positive extraction control, although other configurations are possible. Following collection, the sample 192 is heated in the presence of a lysis agent, such as proteinase K, to facilitate cell lysis and release nucleic acids from the sample 192. This heating step also serves to reduce the viscosity of the biofluid, thereby improving fluid flow characteristics within the microfluidic channels of the cartridge 106 during subsequent processing steps. In some embodiments, the heating can be performed at a temperature between about 55 °C and about 65 °C for a duration of about 10 minutes to about 20 minutes, although other temperature and time parameters may be used depending on the sample type and viscosity. There may be higher heating temperature steps to inactivate any enzymes used. After heating, the cooled heat-treated sample 194 is transferred into a sample syringe 196 that incorporates a Luer lock connection mechanism.

Referring now to FIG. 8B, the heat-treated sample 194 can be processed using the cartridge 106 and the clip 104 through a series of sequential fluid handling operations. More specifically, the processing sequence begins with the clip 104 positioned in the open position and the cartridge 106 installed on the base 102. The sample syringe 196 containing the treated sample 194 is secured to the Luer adapter 180 at the input hole 132 of the cartridge 106. In some embodiments, the sample 192 may be mixed with a binding buffer comprising guanidine hydrochloride, tris hydrochloride, and EDTA to facilitate nucleic acid binding to the silica membrane 168, although other configurations are possible. When the user depresses the plunger of the sample syringe 196, the treated sample 194 is introduced through the input hole 132 and flows through the input channel 134 to the silica membrane cavity 136. As the sample passes through the silica membrane 168, nucleic acids present in the sample bind to the silica matrix and are retained within the silica membrane cavity 136, while the remaining sample fluid, including cellular debris and other non-target components, continues through the valve channel 144 and the waste channel 146 to the waste reservoir 138. Depending on the actuation speed and syringe capacity, delivering approximately 1 mL of fluid to the waste reservoir 138 can take between about 2 seconds and about 24 seconds or more when using a 1 mL syringe, with faster delivery times being achievable using larger syringe capacities, such as a 3 mL syringe, and the delivery rate being dependent on the viscosity of the sample fluid. In some examples, the faster delivery time can be about 2 seconds or about 3 seconds, although other configurations are possible.

Following sample loading, the sample syringe 196 is removed from the input hole 132 and replaced with a wash syringe 198 containing wash fluid. The wash fluid is then delivered through the input hole 132 and follows the same flow path through the silica membrane cavity 136 to the waste reservoir 138, thereby removing contaminants, residues, and excess reagents from the silica membrane 168 while the bound nucleic acids remain captured within the silica matrix. This washing step purifies the collected nucleic acids by eliminating substances that could otherwise interfere with downstream amplification and detection processes. In some embodiments, the assay may not need any wash steps, and in other embodiments, the assay may need two or more wash steps. In some embodiments, the wash step can use the same buffer as the elution step.

Following the washing step, the clip 104 is moved to the installed position, which opens the valve hole 142 associated with the reaction chamber pathway while simultaneously closing the valve hole 142 associated with the waste pathway. An elution syringe 200 containing an elution buffer is then secured to the Luer adapter 180 at the input hole 132 of the cartridge 106. When the user depresses the plunger of the elution syringe 200, the elution buffer flows through the input channel 134 and into the silica membrane cavity 136, where it releases the bound nucleic acids from the silica membrane 168 by disrupting the ionic interactions that previously retained the nucleic acids on the silica matrix, allowing the purified nucleic acids to be released into solution for downstream processing. Alternatively, in some embodiments, a blister pack (not shown) containing pre-measured elution buffer can be used in place of the elution syringe 200 to deliver the elution buffer. In some embodiments, blister packs may also be used to deliver other fluids, such as sample buffer, wash buffer, or lysis reagents, thereby further simplifying the user workflow and eliminating the need for precise volume measurement across multiple processing steps.

In this example, the cartridge 106 can be configured to require relatively low actuation force during syringe operation compared to other microfluidic devices, which may improve ease of use for personnel with limited hand strength or dexterity. In some embodiments, this low force configuration may be achieved by capillary action, which allows the nucleic acids to be released and transported through the channels without requiring high pressure differentials.

The eluted nucleic acids, now suspended in the elution buffer, travel through the valve channel 144, across the open valve hole 142, and through the inlet channel 148 to the reaction chambers 140. As noted above, the reaction chambers 140 can be pre-loaded with lyophilized nucleic acid amplification reagents, such as polymerase chain reaction (PCR) reagents, loop-mediated isothermal amplification (LAMP) reagents, or recombinase polymerase amplification (RPA) reagents, as well as disease-specific primers that target particular nucleic acid sequences. This pre-loading configuration allows the cartridge 106 to be adapted for different disease targets by changing the primer sequences embedded in the reaction chambers 140, allowing for multiplexed detection of multiple pathogens or genetic markers from a single specimen. Upon entering the reaction chambers 140, the eluted nucleic acids rehydrate the lyophilized reagents and initiate the amplification reaction. The fluid continues through the vent channels 150a, 150b and stops at the vent filter 184, which is configured as a hydrophobic membrane that permits air to escape while preventing fluid leakage, thereby allowing the sample to vent properly during subsequent heating operations.

After the elution buffer has been delivered, the clip 104 is moved back to the open position, which closes the valve hole 142 associated with the reaction chamber pathway and blocks the inlet channel 148. The input hole 132 is then sealed with a stopper 202 to prevent evaporation and contamination during the amplification process. The cartridge 106 and, more specifically, the reaction chambers 140 can then be heated to a temperature suitable for nucleic acid amplification, with minimal migration of the reagents between reaction chambers 140 to prevent cross-contamination. By blocking the elution valve hole 142 with the bump 124 of the clip 104 and sealing the input hole 132 with the stopper 202, backflow and fluid movement within the cartridge 106 are substantially prevented, thereby limiting fluid migration and diffusion during heating, and ensuring that each reaction chamber 140 maintains its distinct reagent composition throughout the amplification process.

The base 102 can be engaged with the reader 101 such that the cartridge 106 is inserted into the reader 101 for sample analysis. As illustrated in FIGS. 1 and 8B, the cartridge 106 is configured to be inserted into the reader 101 in an orientation where the vent recess 154 remains positioned outside of the reader 101, thereby allowing heated gases and vapors generated during the amplification process to be vented externally rather than accumulating within the reader 101. This venting configuration prevents pressure buildup within the cartridge 106 and maintains consistent reaction conditions during analysis. In some embodiments, the reader 101 can continuously monitor and detect fluorescence (or other) signals emitted from the reaction chambers 140 during and after the amplification process, allowing quantitative analysis of nucleic acid concentrations in addition to qualitative positive or negative detection. The reader 101 can also include optical components such as excitation light sources and photodetectors that are aligned with the reaction chambers 140 when the cartridge 106 is properly inserted, allowing for real-time or endpoint fluorescence detection, as noted above.

Furthermore, the reader 101 includes the display 108 that provides visual indication of analysis results to a user. For example, the display 108 can include indicator lights of different colors that correspond to different test outcomes. In particular, upon detection of fluorescence above a predetermined threshold, the display 108 may emit a red light to indicate to the user a positive detection of the target substance present in the collected sample. Conversely, if fluorescence is not detected or remains below the threshold, the display 108 may emit a green light to indicate to the user a negative detection of the target substance in the collected sample. In other examples, the display 108 may provide an auditory indicator to the user based on the analyzed result, such as distinct tones or spoken alerts corresponding to positive or negative outcomes. In additional embodiments, the reader apparatus 100 can be connected wirelessly, such as via Bluetooth or Wi-Fi, to an external computer system such as a smartphone, tablet, or laptop/desktop computer, allowing the results of the analysis to be transmitted to the external computer system for display, data logging, remote monitoring, and further analysis.

In some applications, the total diagnostic process illustrated in FIGS. 8A and 8B can be completed in approximately one hour. This time estimate includes approximately 20 minutes for patient sample collection and preparation, and approximately 40 minutes for heating, nucleic acid amplification, and analysis within the reader 101. In some embodiments, the sample collection time may vary depending on the sample type, with saliva samples requiring less collection time than blood or cervical fluid samples. The heating and amplification duration may also be adjusted based on the specific assay requirements and target nucleic acid sequences being detected. In some embodiments, the limit of detection can be as low as about 1.25 copies/μL for DNA and about 25 copies/μL for RNA, with detection times as short as about 30 minutes or less depending on the target concentration, although other configurations are possible.

As shown in FIG. 8B, the sample processing procedure using the clip 104 comprises a streamlined four-step workflow that allows an ease of use by personnel with minimal training or technical expertise. The four steps include sample loading, washing, elution, and sealing, each of which is performed by attaching the appropriate syringe to the input hole 132 and adjusting the position of the clip 104 as needed. As such, the entire fluid handling and valve actuation procedure is user-actuated through manual manipulation of the clip 104 in cooperation with the flexible valve rubber 190 of the cartridge 106, thereby eliminating the need for electrical power sources, mechanical actuators, pneumatic systems, or other external equipment that would otherwise add complexity, cost, and potential points of failure as compared with conventional point-of-care diagnostic designs. Furthermore, the reader apparatus 100, including the reader 101, the base 102, and the clip 104, is designed for repeated use across multiple diagnostic tests. Because the microfluidic cartridge 106 is sealed and self-contained throughout the diagnostic process, the reader apparatus 100 does not require cleaning, decontamination, or sterilization between successive uses, and there is no risk of cross-contamination between patient samples when different cartridges 106 are used for each test.

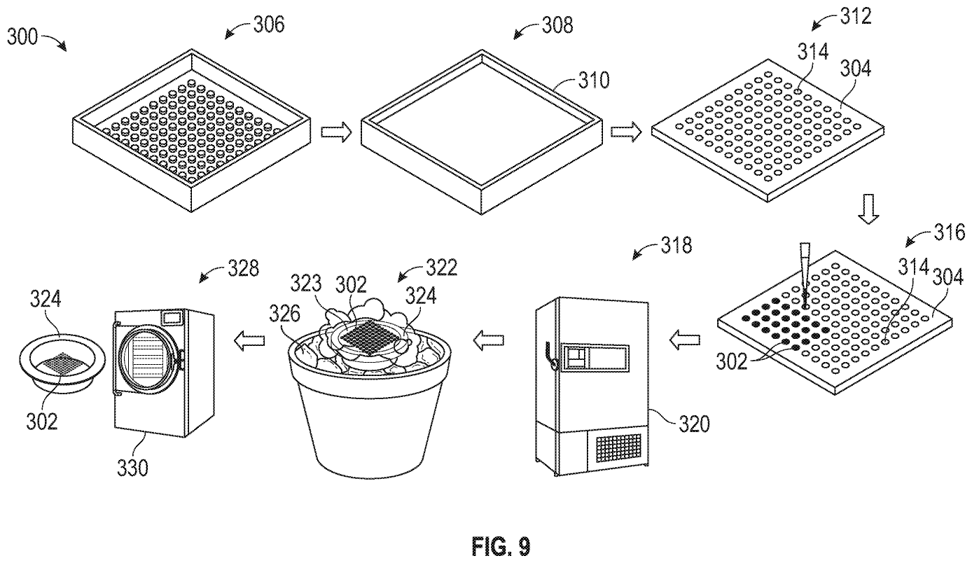

An example method 300 of manufacturing reagents 302 for use in the reaction chambers 140 is shown in FIG. 9. For example, as illustrated in FIG. 9, the method 300 starts at step 306 with designing an initial mold 304 configured to form a reagent 302 having a desired shape. In this case, the desired shape of the reagent 302 can have a profile and size that substantially matches the corresponding reaction chamber 140 the reagent 302 will be received within. This design can be created using a software on a computer (not shown) that enables the creation of any desired shape or size, although other configurations are possible. As one example, computer-aided design (CAD) software can be used to precisely define cavity dimensions, draft angles for ease of reagent release, and surface textures that may affect reagent dissolution rates. Once the design is finalized, at step 308, a corresponding mold casing 310 can be formed. In one example, the mold casing 310 can be 3D printed, and the 3D printing process can utilize stereolithography (SLA), fused deposition modeling (FDM), or selective laser sintering (SLS) techniques, although other configurations are possible. Further, in other examples, the mold casing 310 can be formed via other suitable methods, such as injection molding for higher volume production.

After the mold casing 310 is created at step 308, a liquid silicone rubber or similar substance is poured into the mold casing 310 and is allowed to set. In some embodiments, the mold casing 310 can be treated with a release agent prior to pouring the liquid silicone to facilitate easier demolding. Once solidified, at step 312, the set silicone rubber is released from the mold casing 310, and the released silicone rubber serves as a reagent mold 304 having a base with one or more cavities 314 in the shape of a desired reagent shape. In this example, the liquid silicone can be platinum cure silicone or addition cure silicone, although other configurations are possible. In other embodiments, the reagent mold 304 may be formed from other elastomeric materials having properties similar to silicone rubber, such as low shrinkage, a low glass transition temperature that permits flexibility at frozen reagent temperatures, and sufficient elasticity to allow release of molded reagents without damage. Furthermore, the silicone, or other elastomeric material, can have a durometer between about 0 A and 30 A, or between about 5A and 40 A, or about 15 A. In this example, the durometer range allows the reagent mold 304 to become pliable when molded reagents are still frozen, as will be further described below. In some examples, the durometer of the silicone may be selected based on the final manufacturing process flow, where a softer durometer silicone may facilitate easier release of delicate reagent shapes, while a harder durometer silicone may provide greater dimensional stability and longer mold life over repeated uses.

Following step 312 once the reagent mold 304 is released from the mold casing at step 316, the cavities 314 of the reagent mold 304 can then be filled with liquid reagents 302, such as nucleic acid amplification reagents, although other reagent compositions are possible. For example, in some applications, desired reagents can be mixed with excipients to act as cryoprotectants and bulking agents, which may affect the final appearance and performance of the molded reagents. Suitable excipients may include but are not limited to sugars such as trehalose, sucrose, lactose, or mannitol; amino acids such as glycine; and polysaccharides such as dextran, which can protect reagent components during the freezing and lyophilization processes. Polymers such as polyethylene glycol (PEG) or polyvinylpyrrolidone (PVP) may also be used to provide structural integrity to the solidified reagents 302. In further examples, other additives can be used for desired effects, such as stabilizers to maintain enzyme activity during storage, buffering agents to control pH upon reconstitution, lyoprotectants to preserve reagent functionality during the drying process, antimicrobial agents to maintain sterility, and surfactants such as Tween-20 or Triton X-100 to improve flow and reconstitution characteristics. In some examples, the concentration of these additives may be adjusted based on the specific reagent composition and intended application.

At step 318, the reagent mold 304 containing the reagents 302 is then placed within a freezer 320 having a temperature of about −80 degrees Celsius that is configured to freeze and solidify the reagents 302. In some embodiments, the freezing temperature may range between about −70 degrees Celsius and about −90 degrees Celsius depending on the reagent composition. Accordingly, the freezer 320 may be manipulated and set to different temperatures or temperature ranges that enable different types of reagent compositions to freeze at optimal rates to preserve reagent activity and structural integrity.

Once frozen, at step 322, the reagent mold 304 containing the reagents 302 is then removed from the freezer 320 until the reagent mold 304 becomes slightly pliable such that the molded, solidified reagents 302 may then be removed from the reagent mold 304. The pliability of the silicone reagent mold 304 at this stage facilitates gentle release of the frozen reagents 302 without damaging their shape or structural integrity. Due to its low glass transition temperature, the silicone reagent mold remains flexible at temperatures at which the molded reagents 302 remain solidified. Once separated from the reagent mold 304, the molded reagents 302 are then placed into liquid nitrogen 323 or another suitable cryogenic fluid to further reduce the temperature of the molded reagents 302 for subsequent handling and reduced chance of melting. For example, the molded reagents 302 can be collectively placed in a container 324 containing the liquid nitrogen 323 or other suitable cryogenic fluid, which is then kept on dry ice 326 or other suitable methods to reduce evaporation of the cryogenic fluid. In this example, the liquid nitrogen 323 may have a temperature of approximately −196 degrees Celsius to provide rapid cooling that prevents any partial thawing or deformation of the reagents 302 during handling, although other temperatures are possible. In some embodiments, the container 324 can be made of stainless steel or other material with relatively high thermal mass, an ability to establish good thermal contact with the freeze dryer shelf, and relatively high thermal conductivity. Such characteristics may facilitate more rapid cooling of the container after transport to the freeze dryer, thereby further reducing the likelihood of the solidified reagents melting.

Once solidified by the liquid nitrogen 323, at step 328, the molded reagents 302 (e.g., in the container 324 or another container(s)) can then be placed into a lyophilizing instrument 330, e.g., a freeze dryer, that removes moisture from the molded reagents 302 through sublimation, which further retains the solid shape of the molded reagents 302. The lyophilization process may be conducted at temperatures between about −40 degrees Celsius and about −80 degrees Celsius under vacuum conditions, with drying times varying based on reagent composition and size. In this example, lyophilization may be used to stabilize enzymes and reagents for storage and shipping by removing water content that could otherwise degrade biological components over time. Accordingly, after lyophilization, the reagents 302 may then be stored at room temperature or under controlled conditions for later installation into a corresponding reaction chamber 140 of a microfluidic cartridge 106, or other device, e.g., for use in a point-of-care system. In this way, the lyophilized reagents 302 may exhibit extended shelf life at ambient temperatures, which can facilitate distribution to remote or resource-limited settings where refrigeration may be unavailable.

In some embodiments, the liquid nitrogen 323 is allowed to mostly evaporate once the molded reagents 302 are solidified. For example, a small amount of liquid nitrogen 323 may remain in the container to maintain low temperatures during transport to the freeze dryer 330. In particular, the remaining liquid nitrogen 323 can form a thin layer that does not cover the top of the molded reagents 302, such as reaching about half their height or less. Alternatively, the remaining liquid nitrogen 323 can form a small pool that does not contact all of the reagents 302, provided that a sufficient amount remains to keep the container cold during transfer. In some embodiments, the liquid nitrogen 323 can cover the molded reagents to simplify handling and timing processes, and then the liquid nitrogen 323 will evaporate during lyophilization.

To maintain the structural integrity of the solidified reagents 302 during transfer to the freeze dryer 330, the container 324 holding the reagents 302 may be an insulated vessel, such as a Dewar flask or cryogenic container in some examples, that maintains low temperatures during transport. The insulating properties of such vessels help prevent premature thawing or deformation of the reagents 302 that could otherwise compromise their molded shape. The transport time from the liquid nitrogen bath 323 to the freeze dryer 330 may range from about 30 seconds to about 5 minutes, depending on the laboratory configuration and equipment proximity. During this transfer process, the small amount of remaining liquid nitrogen 323 may continue to evaporate, and any residual liquid nitrogen 323 will fully evaporate during the initial stages of lyophilization within the freeze dryer.

In some applications, the freeze dryer 330 may be pre-cooled to a temperature between about −40 degrees Celsius and about −80 degrees Celsius prior to receiving the molded reagents 302, which can help maintain the structural integrity of the reagents 302 during the transition from liquid nitrogen temperatures to lyophilization conditions. Alternatively, other methods of transport may be possible which keep the container 324 of molded reagents 302 cold during transport to the freeze dryer 330, such as using dry ice or pre-chilled metal trays, which minimize the risk of the reagents 302 melting or deforming during transport.

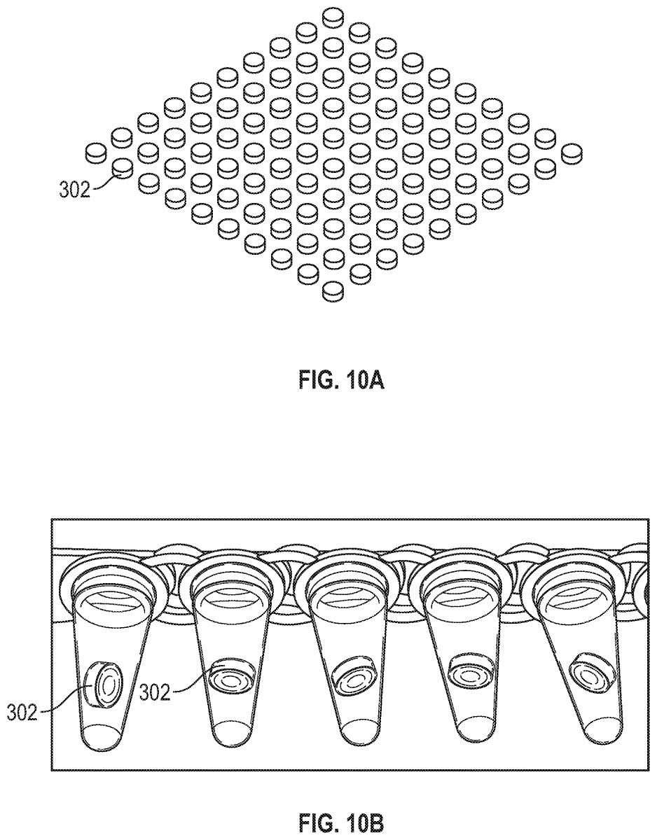

In this example and as illustrated in FIGS. 10A and 10B, the molded reagents 302 have a non-spherical puck or cake shape (e.g., cylindrical) that allows for the molded reagents 302 to fit within the reaction chambers 140 of a thin microfluidic chip profile (e.g., such as cartridge 106), although other reagent shapes such as rectangular, oval, or custom geometries that accommodate corresponding reaction chambers are possible. This shape versatility allows multiple reagents having different profiles and shapes to be easily created using the same process as described above and shown in FIG. 9. Correspondingly, the reusability of the reagent mold 304 further enhances manufacturing efficiency, as the same reagent mold 304 may be used for creating multiple reagent batches having the same desired shape, thereby reducing manufacturing costs and improving batch-to-batch consistency. In particular, once a suitable mold 304 is established, designing the mold casing 310, 3D printing the mold casing 310, and setting a liquid silicone rubber mold may be omitted in subsequent processes, which can significantly reduce production time and material waste. Additionally, the same mold casing 310 can be used to make multiple reagent molds 304. Accordingly, using the methods described herein, lyophilizing reagents in a desired shape can enhance portability and design of the reagents 302 and further eliminates the need for a cold chain, e.g., the maintenance of low temperatures through the lifecycle of the product, that also minimizes the risk of the reagents evaporating before use.

Example reagents 302 formed using method 300 are shown in FIGS. 10A and 10B. In particular, as illustrated in FIGS. 10A, 100 uniform molded reagents 302 are shown, created using a single reagent mold 304; however more or fewer reagents may be formed using the reagent mold 304 depending on the number of cavities and the intended application. For example, the reagent mold 304 may include between about 10 and about 500 cavities, or between about 50 and about 200 cavities, depending on production volume requirements. As noted above, the same reagent mold 304 can be used to create multiple batches of molded reagents 302, or can be reused in subsequent processes, such that a plurality of molded reagents 302 can be formed in an efficient manner. In some embodiments, a single reagent mold 304 may be used to produce hundreds or thousands of reagents 302 before replacement is required, although other configurations are possible. Correspondingly, the reagent mold 304 may contain shapes and profiles that are different from one another such that multiple reagents 302 having different shapes, contours, and/or outlines can be molded for different reaction chamber designs simultaneously and in the same process. For example, a single reagent mold 304 may include cavities of varying diameters, depths, or geometries to accommodate microfluidic cartridges having reaction chambers of different sizes or configurations, allowing a single manufacturing run to produce reagents 302 suitable for multiple cartridge designs.

Still referring to FIGS. 10A and 10B and as noted above, the puck or cake design of the molded reagents 302 has a relatively thin profile. In this example, the puck or cake shape of the molded reagents 302 enables the same amount of volume to be used as would be typically used in conventional designs, while reducing a thicker profile these conventional molded reagents would normally have (e.g., such as a bead or spherical shape). In particular, the thin profile of the puck or cake shape provides a larger surface area-to-volume ratio compared to spherical shapes, which can facilitate faster and more uniform rehydration when the reagents 302 are exposed to elution buffer within the reaction chambers 140.

In contrast to conventional methods that simply drop reagents into liquid nitrogen, which can cause the reagents to naturally form a sphere, the present methods described herein allow the reagent to be shaped into any form to accommodate different design requirements, including non-spherical shapes. This shape flexibility addresses several limitations of spherical reagent designs. For example, using spherical designs with thinner profile chips requires multiple small spheres to be used, which can increase time and complexity for the system. Additionally, small spheres are more easily influenced by static and roll around, making them harder to handle, while non-spherical shapes create increased surface contact, which can help with handling and positioning within the reaction chambers 140. Correspondingly, the flat surfaces of the puck or cake shape also allow for more predictable placement and orientation within the reaction chambers 140, reducing variability in reagent positioning that could otherwise affect assay performance. Furthermore, the non-spherical shape can provide more consistent dissolution characteristics, as the reagent dissolves from the flat surfaces in a more controlled manner compared to the variable dissolution patterns that can occur with spherical reagents. Accordingly, the method 300 allows for use of materials that can shape a reagent into any needed shape and size to accommodate current or future microfluidic cartridge designs.

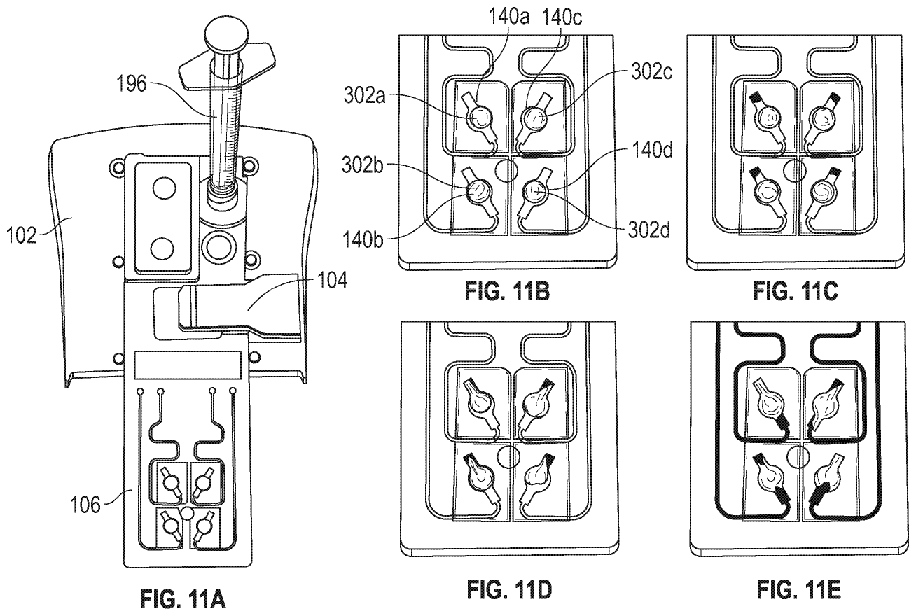

FIGS. 11A-11E illustrate an example use of reagents 302 within a microfluidic cartridge 106, for example, in connection with FIGS. 8A and 8B described above. For example, FIG. 11A shows the cartridge 106 installed on a base 102 with a clip 104 in the open position. A syringe (e.g. sample syringe 196) with a collected sample is further secured onto the input hole 132 (covered in this view).

FIG. 11B illustrates the reagents (e.g., reagents 302a, 302b, 302c, 302d) in each reaction chamber 140 before the elution syringe 200 is deployed. In this example, each reaction chamber 140 (e.g., corresponding reaction chambers 140a, 140b, 140c, 140d) contains a solidified reagent 302a-d having a different primer target. As used herein, a primer target may refer to a specific nucleic acid sequence that the primers within the reagent are designed to amplify. Different primer targets can allow detection of different disease markers, pathogens, or genetic sequences within the same sample. In some embodiments, the primers may be oligonucleotide sequences that are incorporated into the liquid reagent mixture before the molding and lyophilization process described above. In this example, the non-spherical, puck-shaped configuration of the solidified reagents 302a-d allows each reagent to rest at the bottom of its respective reaction chamber 140a-d, with the flat surfaces providing consistent positioning and predictable dissolution characteristics upon rehydration, as noted above. As described herein, the bottom of the reaction chamber 140 refers to the surface of the reaction chamber upon which the solidified reagent rests when installed, such as the surface adjacent to the bottom cover 162.

In order to fill the reaction chambers 140, the clip 104 can be moved to the installed position such that the valve hole 142 in fluid communication with the reaction chambers 140 is open, while simultaneously blocking fluid flow to the waste reservoir 138. An elution buffer (e.g., within elution syringe 200) can then be added through the input hole 132 so that the reaction chambers 140a-d begin to fill with the elution buffer and the released nucleic acids from the silica membrane 168, as discussed above in connection with FIG. 8B and as shown in FIG. 11C. The equidistant inlet channel 148 configuration ensures that the elution buffer reaches each reaction chamber 140a-d simultaneously, promoting uniform rehydration of the solidified reagents 302a-d across all reaction chambers.

Turning now to FIG. 11D, after the initial filling of the elution buffer, the lyophilized reagents 302a-d are rehydrated instantly so as to be displaced and pulled towards a back of the respective reaction chambers 140a-d (e.g., towards the bottom cover 162, or to a same surface where fluid enters the reaction chambers 140a-d). As the elution buffer is fully received within the reaction chamber 140a-d, the reagents 302a-d remain within the reaction chamber 140a-d, mixing with the sample so as to be analyzed by the reader 101, as discussed above and shown in FIG. 11E. In this example, the vent channels 150 have a thinner depth relative to the reaction chambers 140a-d, which can help prevent the reagents 302a-d from exiting the reaction chambers 140a-d during use, as the remaining buffer solution exits the reaction chambers 140a-140d through the vent channels 150.

According to one example, if the sample contains a target substance, the target substance will interact with the reagent 302a-d, causing fluorescence emission within the reaction chamber 140a-d that can be analyzed by the reader 101 and indicated to a user as a positive detection using the display 108. For instance, the fluorescence detection may be performed using optical sensors within the reader 101 that are configured to detect specific wavelengths corresponding to the fluorescent markers present in the reagents 302a-d. In this way, each reaction chamber 140a-d can contain a different primer target that allows the same sample to be tested for different target substances, thereby minimizing the need for multiple test components and samples. For example, a single microfluidic cartridge 106 may be configured to simultaneously test for multiple disease markers or genetic sequences, enabling multiplexed diagnostic capabilities within a single point-of-care test, as noted above.

In the method described with respect to FIGS. 11A-11D, the lyophilized reagents 302a-d are rehydrated with an elution buffer that contains the sample released from the silica membrane 168. However, in some applications, a buffer step may be added prior to sample introduction in order to initially rehydrate the reagents 302a-d before the sample reaches the reaction chambers 140a-d. This pre-rehydration step can help ensure complete dissolution of the lyophilized reagents 302a-d before sample introduction, which may improve assay consistency and reduce variability in reagent reconstitution.

For example, in order to fill the reaction chambers 140, the clip 104 can be moved to the installed position such that the valve hole 142 in fluid communication with the reaction chambers 140 is open. An initial elution buffer (e.g., within elution syringe 200) can then be added through the input hole 132 so that the reaction chambers 140a-d begin to fill with the elution buffer and rehydrate. The volume of the initial elution buffer may be selected to substantially fill the reaction chambers 140a-d while allowing sufficient remaining volume for subsequent sample introduction. After rehydration, which may occur within about 30 seconds to about 5 minutes depending on the reagent formulation and excipient composition, the clip 104 can be moved back to the open position, with the method proceeding as shown in FIG. 8B. In some applications, a brief incubation period may be provided after the initial rehydration step to allow complete dissolution of the lyophilized reagents 302a-d before sample introduction, although other configurations are possible.

In light of the above, some embodiments provide a method of forming solidified reagents for use with microfluidic cartridges. The method can include printing a mold casing, pouring liquid silicone into the mold casing to create a reagent mold, filling the cavities of the reagent mold with reagents, freezing the reagents, and lyophilizing the solidified reagents. In some examples, the solidified reagents can have a puck or cake shape with a thin profile that enables the reagents to fit within reaction chambers of thin microfluidic cartridge designs. This non-spherical shape provides advantages over spherical designs, including increased surface contact for easier handling and positioning, as well as more consistent dissolution characteristics. Furthermore, a rehydration process is provided where solidified reagents are installed in respective reaction chambers of a microfluidic cartridge, with each reagent having a different primer target. Upon addition of an elution buffer, the lyophilized reagents are rehydrated and displaced towards a back of the reaction chambers, where they mix with the sample for analysis. Additionally, the vent channels can have a thinner depth relative to the reaction chambers to prevent the reagents from exiting during use. Accordingly, the molding process enables freeze drying of reagents into any desired shape, especially for low profile microfluidics, which enhances portability and design flexibility. The ability to manipulate reagents for timing and mixing expands the type of diagnostic tests that can be made portable, enabling more complex assays to be performed at the point of care.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

What is claimed is:

1. A method of creating a solidified reagent for use in a microfluidic cartridge, the method comprising:
forming a mold casing having a desired shape;
pouring liquid silicone into the mold casing and allowing the liquid silicone to set to create a reagent mold;
releasing the reagent mold from the mold casing, the reagent mold including a base with a cavity having a non-spherical shape;
filling the cavity of the reagent mold with a liquid reagent;
freezing the liquid reagent in the reagent mold to form a solidified reagent conforming to the non-spherical shape of the cavity;
freeing the solidified reagent from the reagent mold when the reagent mold becomes pliable;
rapidly cooling the solidified reagent using a cryogenic fluid; and
lyophilizing the solidified reagent.

2. The method of claim 1, wherein the reagent mold comprises a plurality of cavities, and wherein filling the cavity comprises filling the plurality of cavities with liquid reagent to form a plurality of solidified reagents.

3. The method of claim 2, wherein the plurality of solidified reagents have uniform shapes.

4. The method of claim 1, wherein the non-spherical shape is a puck or cake shape having a profile configured to fit within a reaction chamber of the microfluidic cartridge.

5. The method of claim 1, wherein the liquid silicone comprises platinum cure silicone having a durometer between about 0 A and 30 A.

6. The method of claim 1, wherein the liquid reagent comprises nucleic acid amplification reagents mixed with excipients comprising at least one of trehalose, sucrose, mannitol, lactose, dextran, glycine, polyethylene glycol, or polyvinylpyrrolidone.

7. The method of claim 1, further comprising allowing the cryogenic fluid to partially evaporate prior to lyophilizing.

8. The method of claim 1, further comprising installing the lyophilized solidified reagent into a reaction chamber of the microfluidic cartridge.

9. The method of claim 8, further comprising rehydrating the lyophilized solidified reagent within the reaction chamber.

10. A reagent mold for solidifying liquid reagents for use in microfluidic cartridges, comprising:
a silicone base; and
a plurality of cavities formed in the silicone base, each cavity having a non-spherical shape configured to receive a liquid reagent and form a solidified reagent having a profile and size substantially matching a corresponding reaction chamber of a microfluidic cartridge,
wherein the silicone base has a durometer configured to allow the reagent mold to become pliable when the solidified reagents are frozen.

11. The reagent mold of claim 10, wherein the non-spherical shape is a puck shape.

12. The reagent mold of claim 10, wherein the plurality of cavities includes cavities having different shapes configured to form solidified reagents for reaction chambers of different sizes or configurations.

13. The reagent mold of claim 12, wherein the plurality of cavities includes between about 10 and about 500 cavities.

14. The reagent mold of claim 10, wherein the silicone base comprises platinum cure silicone.

15. The reagent mold of claim 10, wherein the reagent mold is reusable for creating multiple batches of solidified reagents.

16. A method of analyzing a test sample using a microfluidic cartridge having a plurality of reaction chambers, a waste reservoir, and a silica membrane, the method comprising:
installing a plurality of non-spherical lyophilized reagents into the plurality of reaction chambers;
collecting the test sample;
installing a clip on the microfluidic cartridge in a first position to block fluid flow to the plurality of reaction chambers;
providing the test sample to an input hole of the microfluidic cartridge;
placing the clip in a second position to block fluid flow to the waste reservoir and open fluid flow to the plurality of reaction chambers;
adding an elution buffer through the input hole to rehydrate the lyophilized reagents; and
analyzing the test sample within the plurality of reaction chambers.

17. The method of claim 16, further comprising providing a wash fluid through the input hole to wash the silica membrane prior to placing the clip in the second position.

18. The method of claim 16, wherein the lyophilized reagents are displaced towards a back of the respective reaction chambers upon rehydration, the back of the respective reaction chambers being a same surface to where fluid enters the reaction chambers.

19. The method of claim 16, wherein vent channels of the cartridge have a thinner depth relative to the plurality of reaction chambers to prevent the lyophilized reagents from exiting the plurality of reaction chambers.

20. The method of claim 16, further comprising providing an incubation period after rehydrating the lyophilized reagents to allow complete dissolution of the lyophilized reagents prior to analyzing the test sample.
